(19) United States
(12) Patent Application Publication
(10) Pub. No.: US 2008/0117965 A1
(43) Pub. Date: May 22, 2008

(54) Multiple-Channel Codec and Transcoder Environment for Gateway, Mcu, Broadcast, and Video Storage Applications

(75) Inventors: Vladimir Vysotsky, Fremont, CA (US); Lester F. Ludwig, Redwood Shores, CA (US); Roger Summerlin, Keller, TX (US); J. Chris Lauwers, Mountain View, CA (US)

Correspondence Address: SUGHRUE MION, PLLC, 2100 Pennsylvania Avenue, N.W., Washington, DC, 20037, US

(73) Assignee: COLLABORATION PROPERTIES, INC., San Mateo, CA (US)

(21) Appl. No.: 11/814,671

(22) PCT Filed: Jan. 12, 2006
(86) PCT No.: PCT/US06/01358

§ 371 Date: Jan. 24, 2008

Related U.S. Application Data
(63) Continuation-in-part of application No. 11/246,867, filed on Oct. 7, 2005.
(60) Provisional application No. 60/647,168, filed on Jan. 25, 2005.

(51) Int. Cl. H04N 11/02; H04N 7/14

(52) U.S. Cl. 375/240.01; 348/14.09; 348/E07.084; 375/E07.076

(57) ABSTRACT

An environment for integrating a collection of video and audio processors into a multifunction system ideally suited for a common board in a hosted system. Codec and transcoding functions may be autonomous, operate under external control, be managed by a common chaperoning processor, or operated in combinations of each of these ways. The plurality of reconfigurable media signal processors can cooperatively support a variety of concurrent independent or coordinated tasks so as to provide on-demand network functions such as flexibly reconfigurable A/V transcoding, broadcast, video storage support, video mosaicing, etc., each supporting a variety of analog and digital signal formats. The system can be used for networked video services such as conferencing MCU functions, streaming transcoding record and playback video storage, call recording, conference recording, video answering (greeting playback, message record), and other functions. The architecture permits graceful growth, supporting a larger number of co-executing tasks as software algorithms become more efficient and future reconfigurable processors become more powerful, thus providing important architectural continuity.

### CROSS-REFERENCE TO RELATED APPLICATION

This application claims the benefit of priority to U.S. Provisional Patent Application No. 60/647,168 filed on Jan. 25, 2005, under the same title, which is incorporated by reference in its entirety for all purposes as if fully set forth herein.

### BACKGROUND OF THE INVENTION

This invention relates to video communications and signal processing, and more specifically to the compression, decompression, transcoding, and/or combining of audio and/or video signals among various digital and/or analog formats.

### SUMMARY OF THE INVENTION

The invention comprises an environment for integrating a collection of video and audio compression and decompression engines into a system ideally suited for a common electronic circuit board or yet more compact subsystem. These compression and decompression engines, which will be called “media processors,” may be autonomous, operate under external control, be managed by a separate common chaperoning processor, or combinations of each of these.

The chaperoning processor may divide session management, resource allocation, and housekeeping tasks among itself, the media processors, and any external processing elements in various ways, or may be configured to operate in a completely autonomous and self-contained manner.

The resulting configuration may be used as an analog/digital codec bank, codec pool, fixed or variable format transcoder or transcoder pool, continuous presence multimedia control unit (MCU), network video broadcast source, video storage transcoding, as well as other functions in single or multiple simultaneous signal formats.

One aspect of the invention provides for flexible environments where a plurality of reconfigurable media signal processors cooperatively coexist so as to support a variety of concurrent tasks.

In a related aspect of the invention, several independent codec sessions can be supported simultaneously.

In another aspect of the invention, the reconfigurable media signal processors include abilities to cooperatively interwork with each other.

In another related aspect of the invention, flexibly reconfigurable transcoding is provided for signals conforming to one compression standard to be converted to and from that of another compression standard.

In another aspect of the invention, encoder/decoder pair software is unbundled into separately executable parts which can be allocated and operate independently.

In another aspect of the invention, resource availability is increased for cases when signal flow is unidirectional by not executing unneeded portions of bidirectional compression algorithms.

In another aspect of the invention, a common incoming signal can be converted into a plurality of outgoing signals conforming to differing compression standards.

In another aspect of the invention, the system can provide needed functions involved in implementing a video conferencing MCU supporting a variety of analog and digital signal formats.

In another aspect of the invention, the system can provide functions involved in implementing a streaming transcoding video storage playback system, supporting a variety of analog and digital signal formats.

In a related aspect of the invention, the system can implement a streaming transcoding video storage system broadcasting video conforming to a variety of analog and digital signal formats.

In another related aspect of the invention, the system can implement a streaming transcoding video storage system simultaneously broadcasting a plurality of video signals, each conforming to selected plurality of differing video signal formats.

In another aspect of the invention, the system can provide functions involved in implementing a streaming transcoding video storage system in record modes, and in this receiving video and audio in any of a variety of analog and digital signal formats.

In another related aspect of the invention, the system can implement a video call the recording of a video call.

In another related aspect of the invention, the system can implement the recording of a video conference.

In another related aspect of the invention, the system can implement a recording function of a video answering system.

In another related aspect of the invention, the system can implement a playback function of a video answering system.

### In another aspect of the invention, the system can be reconfigured on demand.

In another aspect of the invention, the system can be reconfigured in response to on-demand service requests.

In another aspect of the invention, the system software includes modularization of lower level tasks in such a way that facilitates efficient reconfiguration on demand.

In another aspect of the invention, the system software is structured so that some tasks may be flexibly allocated between local controlling processor and a media processor.

In another aspect of the invention, the system grows gracefully in supporting a larger number of co-executing tasks as software algorithms become more efficient.

In another aspect of the invention, the system provides important architectural continuity as future reconfigurable processors become more powerful.

In another related aspect of the invention, the system can implemented with standard signal connectors rather than bus-based I/O connections so as to provide stand-alone implementation without physical installation in a host system chassis.

### BRIEF DESCRIPTION OF THE DRAWINGS

The above and other aspects, features and advantages of the present invention will become more apparent upon consideration of the following description of exemplary and preferred embodiments taken in conjunction with the accompanying drawing figures.

FIG. 1a illustrates a basic configuration involving a number of analog-to-digital and digital-to-analog elements and a number of encoder/decoder elements.

FIG. 1b illustrates the addition of a locally controlling processor.

FIGS. 2a and 2b illustrate the incorporation of reconfiguration capabilities within the invention.

FIGS. 3a-3c illustrate the incorporation of analog and digital I/O switching capabilities within the invention.

FIG. 4 illustrates the incorporation of digital switching capabilities to allow arbitrary linking of selected analog-to-digital and digital-to-analog elements with selected encoder/decoder elements in various interconnection arrangements.

FIGS. 5a-5c illustrates reconfiguration capabilities that may be added to the arrangement of FIG. 4 as provided for by the invention.

FIGS. 6a-6d illustrates various configurations for transcoding operations as provided for by the invention.

FIGS. 7a-7b illustrates the computational load implications of encoding or decoding four video images of quarter size versus one video image of full size. This is useful in flexible task allocation as well as for exemplary video MCU function implementations as provided for by the invention.

FIGS. 8a-8d illustrate resource allocation abstractions useful in session management as provided for by the invention.

FIG. 9 illustrates differences in the probability of blocking for two classes of tasks sharing the same pooled capacity as a function of the ratio of resource requirements for each class of task.

FIGS. 10a-10c illustrate increasing degrees of flexible resource allocation as associations between encode tasks, decode tasks, and real-time media processors are unbundled. FIG. 10d continues adding reconfiguration flexibility by including allocations of bus bandwidth and separable allocations of unbundled analog/digital conversions.

FIG. 11a illustrates an exemplary high-level architecture for implementing analog and digital I/O aspects of the invention applicable to contemporary commercially available components. FIG. 11b illustrates exemplary alternate configurations for purely digital I/O, including support for high performance digital video formats. FIG. 11c illustrates an additional exemplary alternate configuration for a host providing an optical bus interface.

FIG. 12a illustrates an exemplary signal flow for a bidirectional codec operation that could readily be executed in the parallelized multi-task environment of the exemplary embodiment depicted in FIG. 11a. FIG. 12b illustrates an exemplary signal flow for a unidirectional transcoding operation that could readily be executed in the parallelized multi-task environment of the exemplary embodiment depicted in FIG. 11a.

FIG. 13 illustrates an exemplary real-time dispatch loop adaptively supporting a plurality of real-time jobs or active objects. Here, a real-time job manager, which manages all other real-time jobs or active objects, is itself a co-executed real-time job or active object.

FIG. 14a illustrates an exemplary tasks associated with implementing an instance of the signal flow procedure of FIG. 12 into a smaller collection of real-time jobs or active objects. FIG. 14b illustrates an exemplary aggregation of these into higher-level modular real-time jobs or active objects.

FIG. 15 illustrates two exemplary ranges and selections of choices of protocol task allocation between a media processor and an associated local controlling processor.

### DETAILED DESCRIPTION OF THE INVENTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

High-performance video and audio compression/encoding and decompression/decoding systems are commonly in use today and have been available in increasingly miniature forms for many years. In production environments, encoders are used in isolation to record DVDs and to create MPEG video clips, movies, and streaming video. These encoders are typically hardware engines, but can be implemented as batch software programs. In delivery environments, decoders are used in isolation to render and view DVDs, MPEG video clips, movies, and streaming video on computers, set-top boxes, and other end-user hardware. Recently, such decoders are typically implemented in software, but higher-performance hardware systems are also common. In video editing systems, both encoders and decoders often exist in a common system, and there may be more than one decoder available in order to support multiple decoding sessions as part of commonplace video editing tasks. The multiple decoders may be software only. In some cases, several high-performance decoders may coexist in a single board-level system. Single board-level systems comprising an encoder/decoder pair also exist. These, too, are used in video editing but are more commonplace in video conferencing systems where they regularly comprise any of a wide variety of video codecs.

In these single board-level systems comprising an encoder/decoder pair, typically only one compression standard (such as MPEG1/2/4, H.261/263/264, etc.) is supported. These typically provide parameter adjustments such as bit rate, quantization granularity, inter-frame prediction parameters, etc., as provided for in the standard Software decoders initially were similar, although there is increasing support for more than one compression standard. Recently, new powerful media signal processors have appeared which can support pre-execution downloads of a full high-performance video and audio encoder/decoder pair of essentially arbitrary nature, specifically targeting existing video and audio compression standards. This, in principle, makes it possible to create a video and audio encoder/decoder pair within the scope of a physically small single board-level system.

The present invention develops such emergent capability further by creating environments where a plurality of reconfigurable media signal processors cooperatively coexist so as to support a variety of concurrent tasks. In the most straightforward implementation, several independent codec sessions can be supported simultaneously, wherein “session” will be taken to mean not only a granted request for the allocation of resources for a contiguous interval of time but, in a further aspect of the invention, a configuration of those resources maintained for a contiguous interval of time. Considerable additional value is obtained by further providing the reconfigurable media signal processors with abilities to cooperatively interwork. One example of this is providing for transcoding signals conforming to one compression standard to and from that of another compression standard. Yet more value can be obtained by unbundling encoder/decoder pair software into separately executable parts that can be allocated and operate independently. One example of this is the conversion of a common incoming signal into one or more outgoing signals conforming to differing compression standards. Another is increased resource availability when signal flow is unidirectional or bidirectional (“two-way”) compression sessions are not needed. Further, such a system can provide the needed functions involved in implementing a video conferencing MCU or streaming transcoding video storage system, each supporting a variety of analog and digital signal formats sequentially or simultaneously. Additionally, such a system grows gracefully in supporting a larger number of co-executing tasks as software algorithms become more efficient. No less importantly, such a system also provides important architectural continuity as future reconfigurable processors become more powerful and agile.

The overview of the functionalities, capabilities, utility, and value of the invention thus provided, the invention is now described in further detail.

1. Basic Structure and Functionality

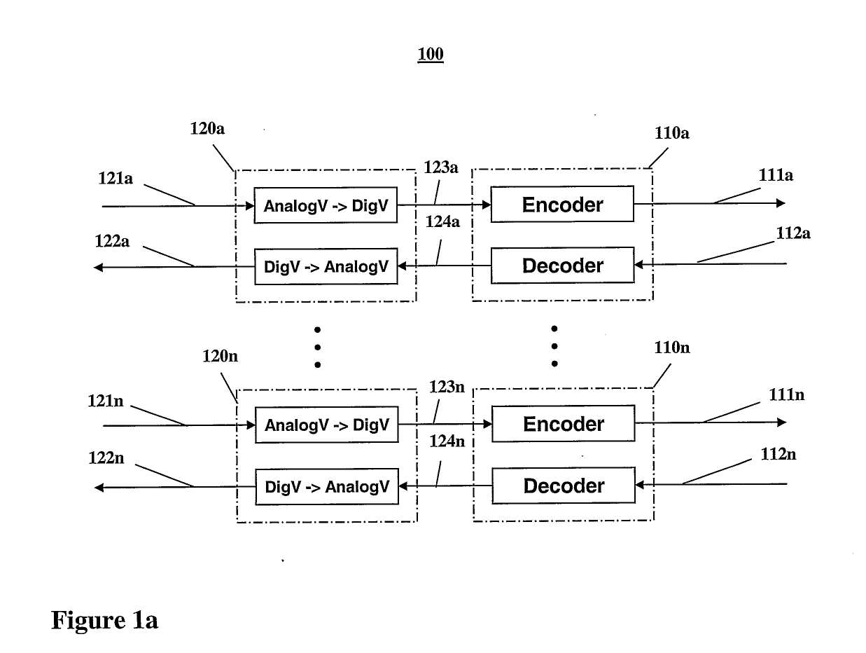

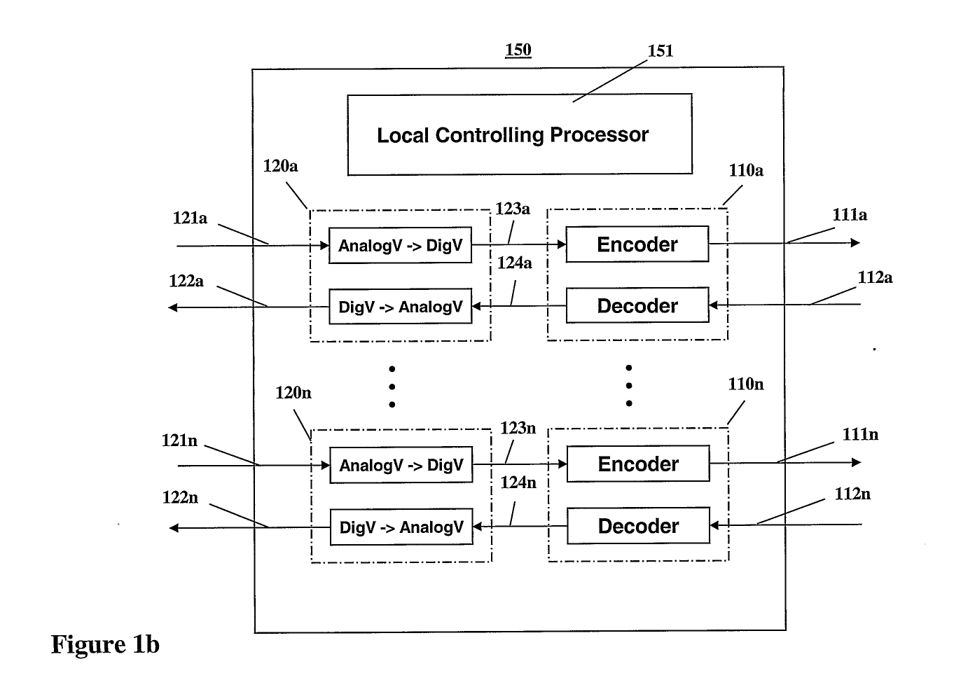

FIG. 1a depicts a simply-structured exemplary system 100 provided for by the invention. This exemplary system 100 comprises a plurality of encoder/decoder pairs 110a-110n, each uniquely associated with bidirectional analog/digital conversion elements 120a-120n. Other arrangements provided for by the invention also include those without the bidirectional analog/digital conversation elements 120a-120n and those with additional elements such as digital switches, analog switches, one or more locally controlling processors, bus interfaces, networking and telecommunications interfaces, etc. These will be described later in turn.

Referring to FIG. 1a, the bidirectional analog/digital conversation elements 120a-120n each comprise not only D/A and A/D converters, but also means for scan-sync mux/demux, luminance/chrominance mux/demux, chrominance-component composing/decomposing, color burst handling, etc. as relevant for conversion among analog composite video signals 121a-121n, 122a-122n and raw uncompressed digital representations 123a-123n, 124a-124n. The encoder/decoder pairs 110a-110n provide compression and decompression operations among the raw uncompressed digital representations 123a-123n, 124a-124n and the compressed signals 111a-111n, 112a-112n.

The analog composite video signals 121a-121n, 122a-122n similarly are typically in compliance with a published industry-wide standard (for example NTSC, PAL, SECAM, etc.). The compressed signals 111a-111n, 112a-112n themselves and the operations performed by encoder/decoder pairs 110a-110n are typically in compliance with a published industry-wide standard (for example H.261, H.263, H.264, MPEG-1, MPEG-2, MPEG-4, etc.) or may be a proprietary standard (such as the wavelet compression provided by Analog Devices ADV601™ chip, etc.). Although not explicitly included nor excluded in this view, the encoder/decoder pairs 110a-110n may or may not further internally provide support for various existing and emerging venues and protocols of digital transport (for example, IP protocol, DS0/DS1 formats for T carrier, ISDN, etc.).

The encoder/decoder pairs 110a-110n may each be implemented as a dedicated hardware engine, as software (or firmware) running on a DSP or generalized processor, or a combination of these. When implemented as software, the encoding and decoding algorithms may be implemented as a common routine, as separate routines timesharing a common processor, or a combination of these. When encoders and decoders are implemented as separate routines permitting timeshared concurrent execution on a common processor, a wide range of new functionality is made cost-effectively possible. Several aspects of the invention leverage this capability in a number of ways as will be subsequently discussed.

Each encoder/decoder of the encoder/decoder pairs 110a-110n may operate independently, or may have various aspects and degrees of its operation governed by common shared coordinating processing. The common shared coordinating processing can be performed by one or more processors, each of which may be local to the system, external to the system, or a combination of these. FIG. 1b shows the explicit addition of a locally controlling processor 150 that may be shared by the encoder/decoder pairs 110a-110n. This locally controlling processor 150 may cooperate with or be controlled by one or more external processors. The local processor may perform any of the following:
mundane tasks such as bus operation and housekeeping;
more comprehensive tasks such as full session management;
low-level tasks such as resource allocation functions;
higher level server-like session/resource allocation functions;

or any combination of these, as well as other possible functions. Examples of other possible functions include IP connection implementation, Q.931 operation, H.323 functions, etc. The locally controlling processor 150 may also control some of the additional elements to be described later such as digital switches, analog switches, one or more locally controlling processors, bus interfaces, networking and telecommunications interfaces, etc.

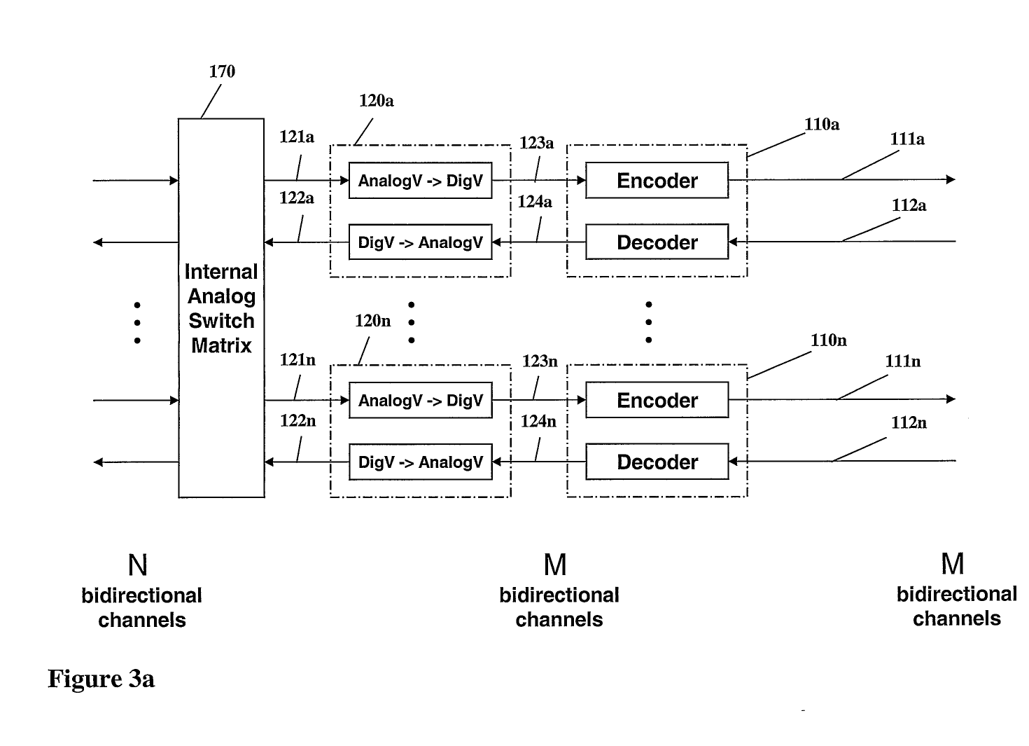

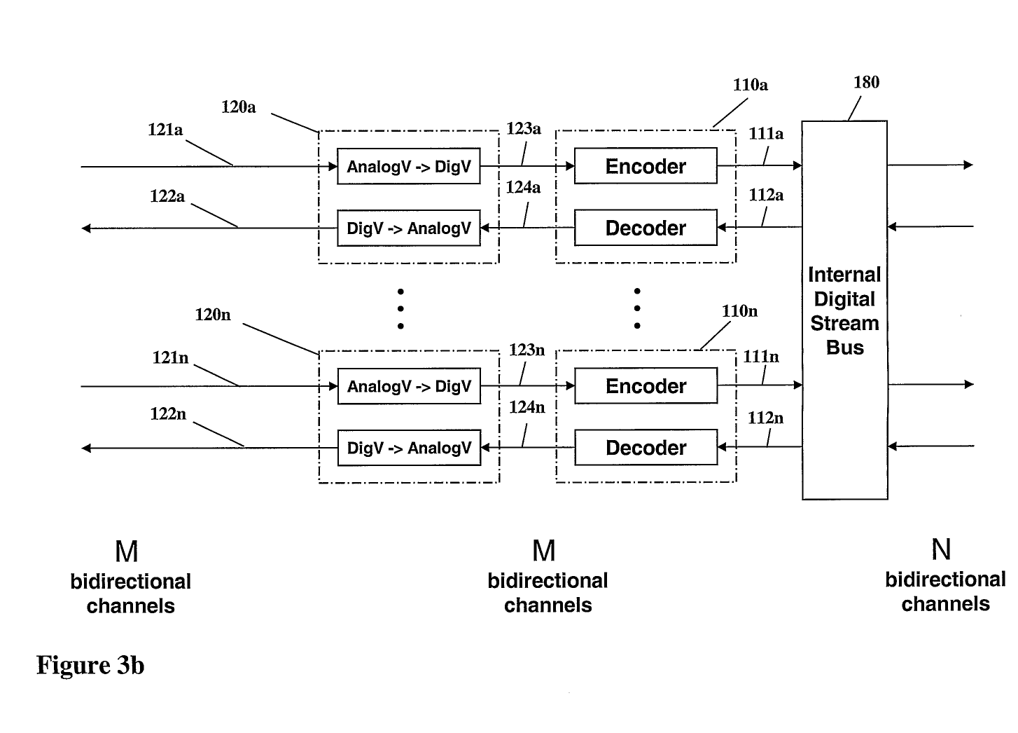

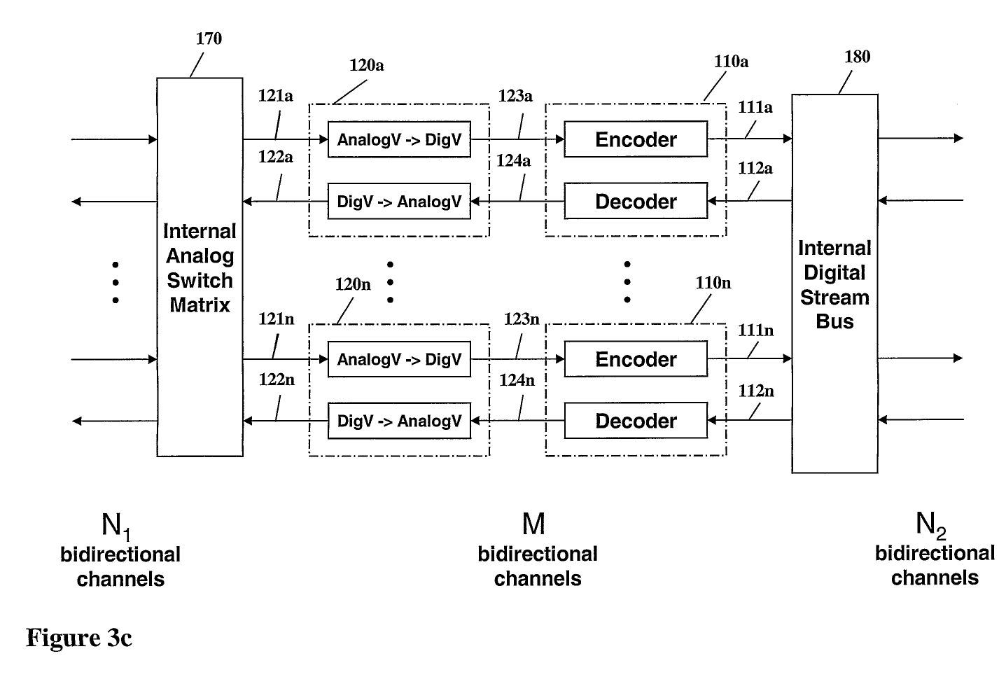

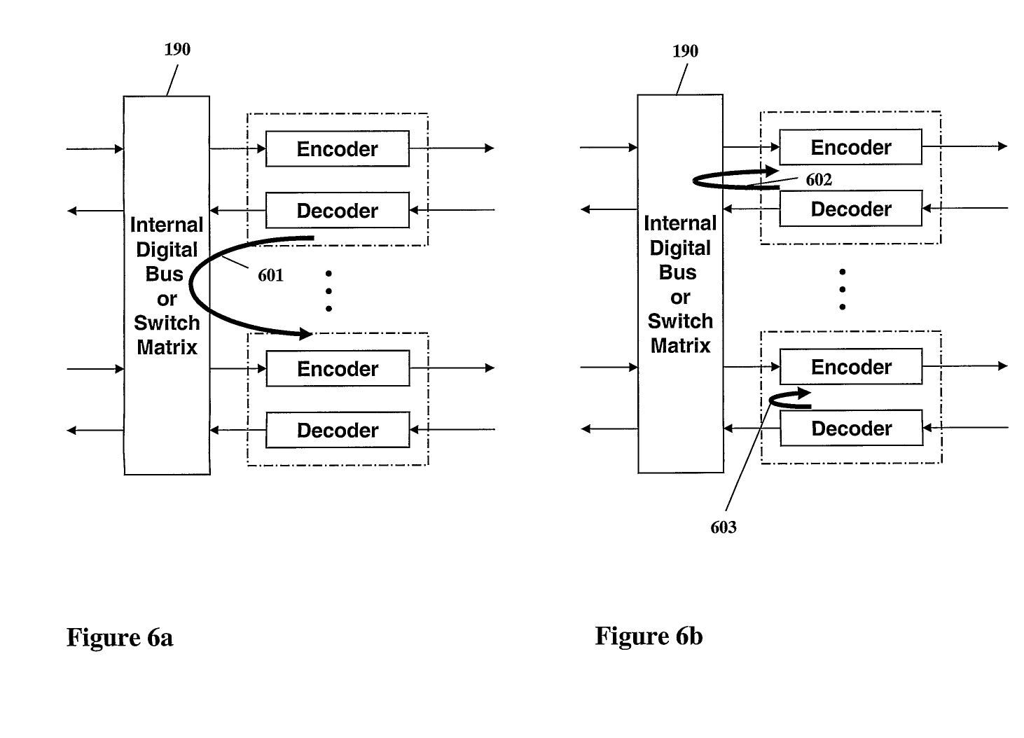

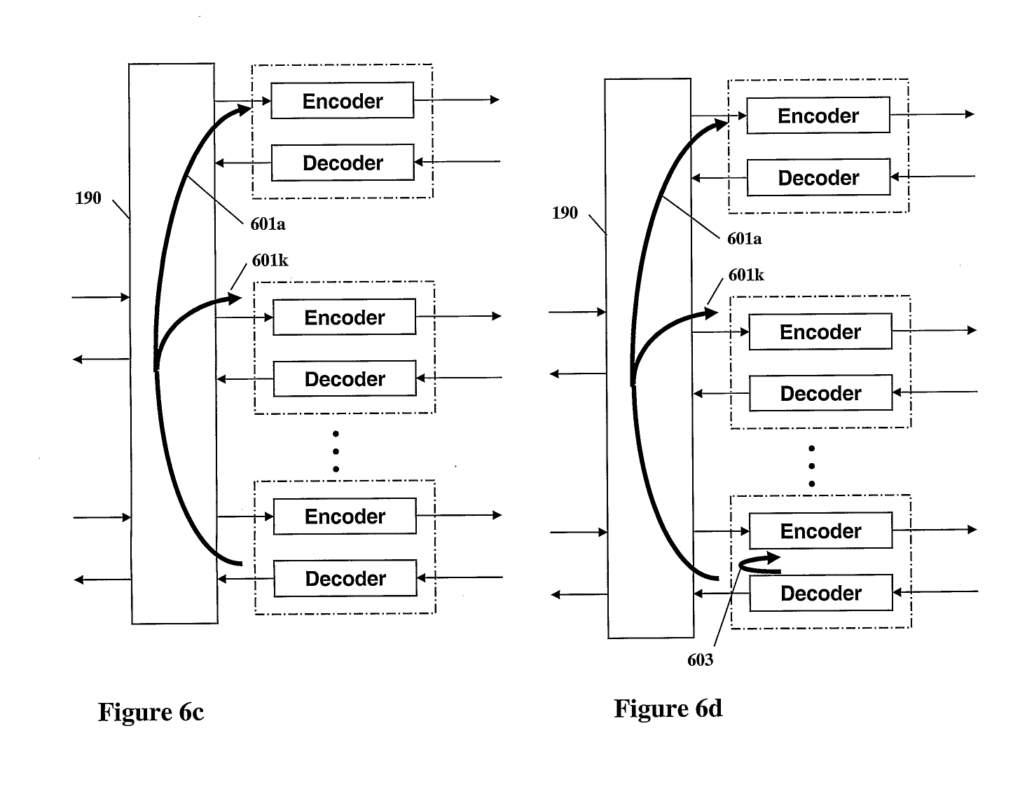

The arrangements described thus far and forward now through FIG. 3, to be discussed, show dedicated interconnections (such as 123a-123n, 124a-124n) between the analog/digital conversation elements 120a-120n and encoder/decoder pairs 110a-110n. Other implementations provided for by the invention allow for switched (rather than dedicated) interconnections between the analog/digital conversation elements 120a-120n and encoder/decoder pairs 110a-110n. Additionally, the configurations described thus far and forward now through FIG. 6, to be discussed, show the explicit incorporation of analog/digital conversation elements 120a-120n. Other implementations provided for by the invention include configurations where no analog/digital conversion elements 120a-120n are involved or included. These will be considered in more detail in Section 1.2.

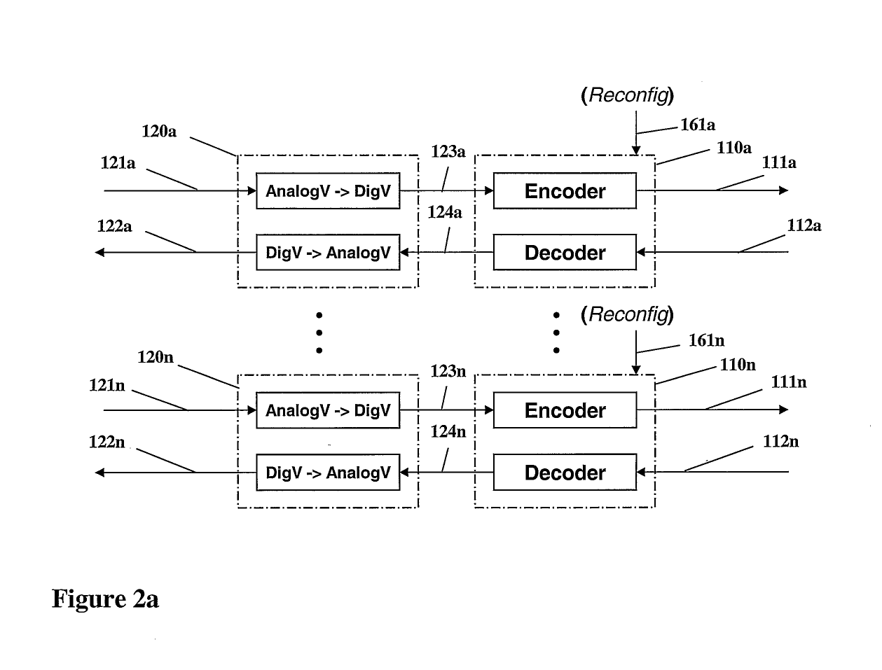

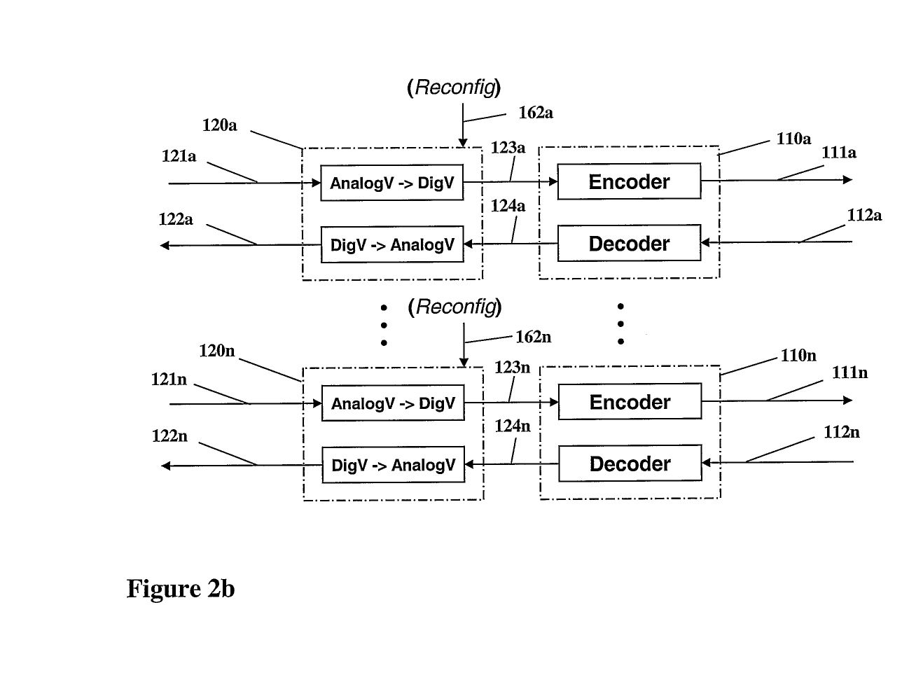

An important note going forward: in order to simplify FIGS. 2 through 6 a locally controlling processor 150 is not explicitly shown. In most practical cases it is present and thus readily assumed in the discussion regarding the control of at least some of the elements in these Figures.

### 1.1 Reconfigurations Via Controlled Compression Algorithm Download

As stated earlier, the encoder/decoder pairs 110a-110n may each be implemented as a dedicated hardware engine, as software (or firmware) running on a DSP or generalized processor, or a combination of these. In any of these situations it is often advantageous or necessary to at least set the value of parameters of operation. In the case where encoder/decoder pairs 110a-110n are implemented in part or in full as software running on a DSP or generalized processor, it may be desirable to download parts or all of the software into the DSP or generalized processor on a session-by-session, or perhaps even intra-session, basis. For ease of discussion, the entire range of reconfiguring anything between parameter settings to entire algorithms will be referred to as “reconfiguration.” FIG. 2a shows encoder/decoder pairs 110a-110n under the influence of any such range of reconfiguration actions 161a-161n. The reconfiguration actions may be made by any locally controlling processor(s) 150, by external controlling processor(s), or by other means.

In a similar way, it may be advantageous or necessary to set the value of parameters of operation pertaining to the analog/digital conversation elements 120a-120n. For example, each analog/digital conversation element may support a variety of analog protocols (such as NTSC, PAL, SECAM). The conversion may also support a range of parameters such as sampling rate/frame rate, sampling resolution, color models (YUV, RGB, etc.) and encoding (4:2:2, 4:1:1, etc.). The digital stream may have additional adjustable protocol parameters as well. FIG. 2b shows analog/digital conversation elements 120a-120n under the influence of any such range of reconfiguration actions 162a-162n. The reconfiguration actions may be made by an associated encoder/decoder from the collection of encoder/decoder pairs 110a-110n, by any locally controlling processor(s) 150, by external controlling processor(s), or by other means.

### 1.2 Reconfigurations Via Controlled Internal Switching and Distribution

The invention provides for expanding upon the arrangement illustrated in FIG. 1a through FIG. 2b by adding an internal analog switching capability between the analog/digital conversation elements 120a-120n and connections to external signal sources and signal destinations. FIG. 3a illustrates an embodiment utilizing an analog switch matrix 170, although an analog bus or other switch implementation can be used in its place. In its raw form, the resulting functionally is useful in a number of situations, including:
Implementing codec pools for analog workstations in a small office;
teleconferencing systems, video monitoring systems, video production systems, etc.;
Providing redundancy for fail-safe designs;
Providing access to a selection of dedicated hardware encoder/decoder engines, each exclusively dedicated to an individual or narrow range of encoding/decoding capabilities;
Providing access to encoder/decoder pairs, each exclusively dedicated to an individual digital communications path, digital communications protocol, or digital communications venue (i.e., IP, ISDN, etc.);
Support for outgoing analog multicasting.

The invention further provides for expanding upon the arrangement illustrated in FIG. 1a through FIG. 2b by adding an internal digital switching capability between the encoder/decoder pairs 110a-110n and connections to external signal sources and signal destinations. FIG. 3b illustrates an embodiment utilizing a digital stream bus 180, although a digital matrix switch or other switch implementation can be used in its place. In its raw form, the resulting functionally is useful in a number of situations, including:
Implementing codec pools for analog workstations in a small office; teleconferencing systems, video monitoring systems, video production systems, etc.;
Providing network redundancy for fail-safe network deployments;
Providing access to a selection of dedicated analog/digital conversation elements 120a-120n, each exclusively dedicated to an individual video source and/or destination;
Support for outgoing digital multicasting.

FIG. 3c combines the switches 170 and 180 of FIGS. 3a and 3b. Such a system can support M bidirectional sessions connecting among N₁ bidirectional analog channels and N₂ bidirectional digital channels and where it is possible to have N₁=N₂. In its raw form, the resulting functionally is useful in a number of situations, including:
Implementing codec pools for analog workstations in a small to very large office teleconferencing systems, video monitoring systems, video production systems, etc.;
Providing access to a selection of dedicated hardware encoder/decoder engines, each exclusively dedicated to an individual or narrow range of encoding/decoding capabilities;
Providing codec redundancy for fail-safe implementations;
Providing network redundancy for fail-safe network deployments;
Support for outgoing analog multicasting;
Support for outgoing digital multicasting.

This arrangement also facilitates a wide range of additional capabilities when additional features are included and leveraged as will become clear in the discussion that follows.

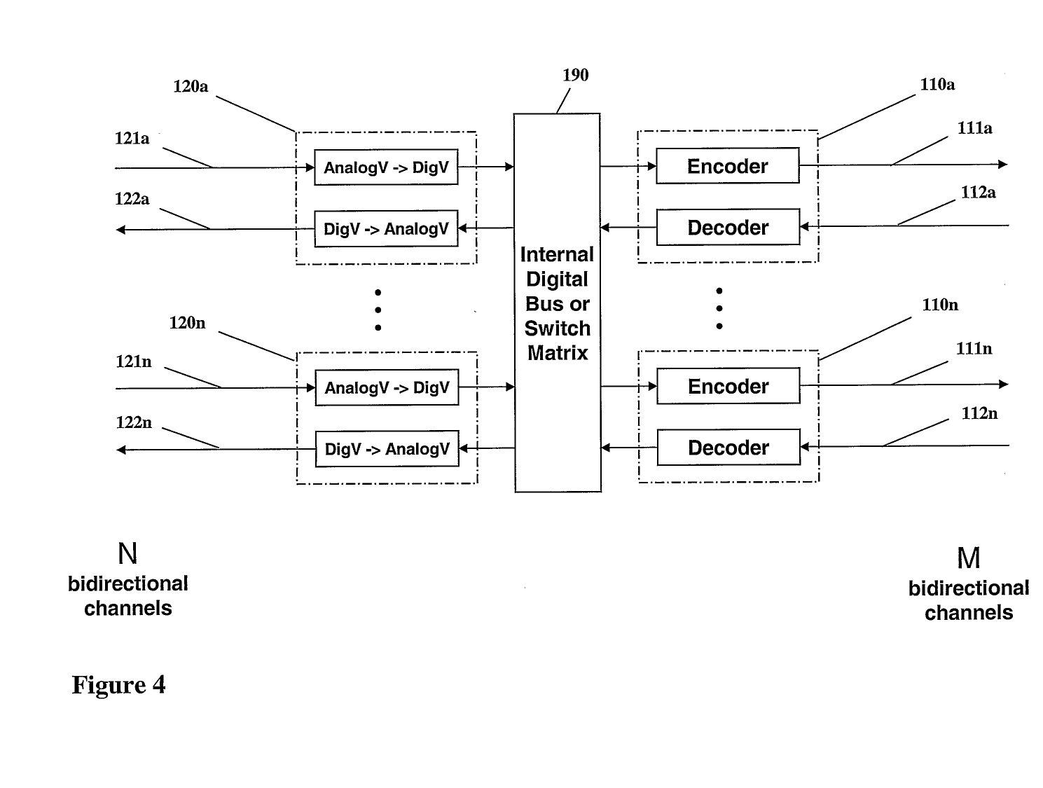

As stated earlier, the invention provides for further expansions upon the arrangement illustrated in FIG. 1a through FIG. 3c by providing for switched interconnections between the analog/digital conversation elements 520a-520n and encoder/decoder pairs 110a-110n. FIG. 4 illustrates the introduction of a digital bus or switch matrix 190 in place of the dedicated interconnections 123a-123n, 124a-124n in FIG. 1a forward. Note that this addition makes possible several additional lower-level capabilities:
Encoder/decoder pairs can be freely assigned to any real-time media processor;
The total number of analog/digital conversation elements 120a-120n can now differ from the total number of encoder/decoder pairs 110a-110n;
Further, if the digital bus or switch matrix 190 is such that encoders and decoders of selected encoder/decoder pairs 110a-110n can be cross-connected, this addition facilitates one way to support fully digital transcoding (as will be explained).

The resulting aggregated arrangement provides reconfigurable access to unbundled lower-level capabilities and as such gives rise to a rich set of higher-level capabilities as will be discussed.

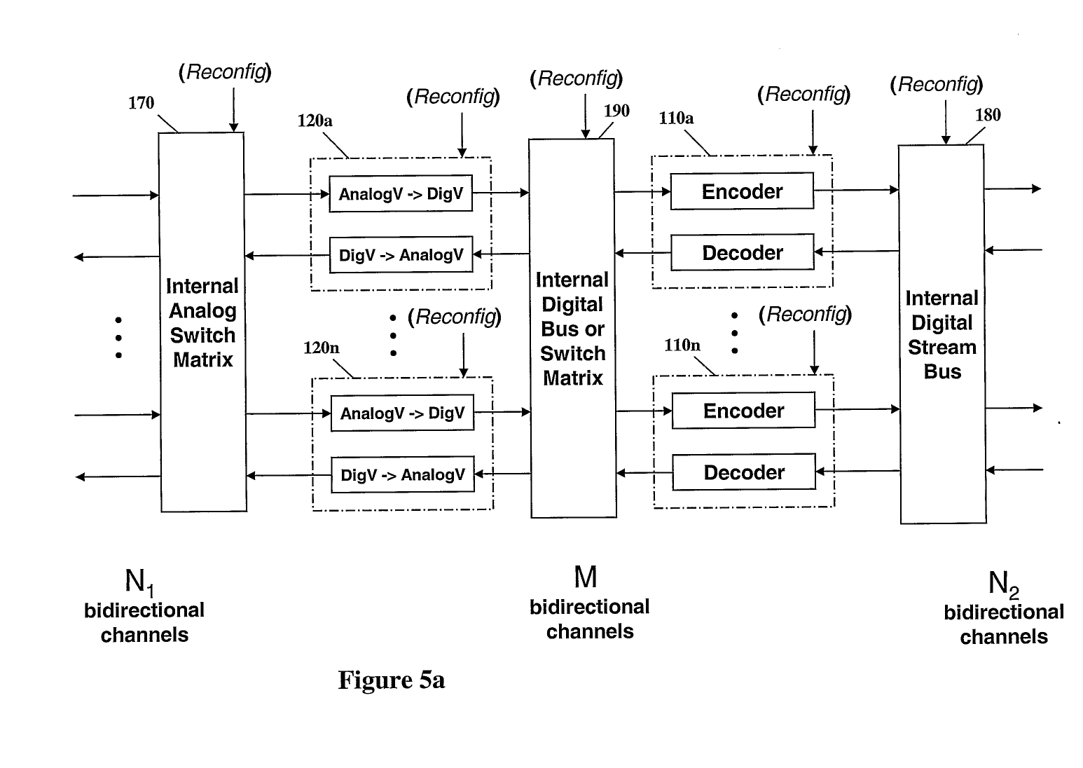

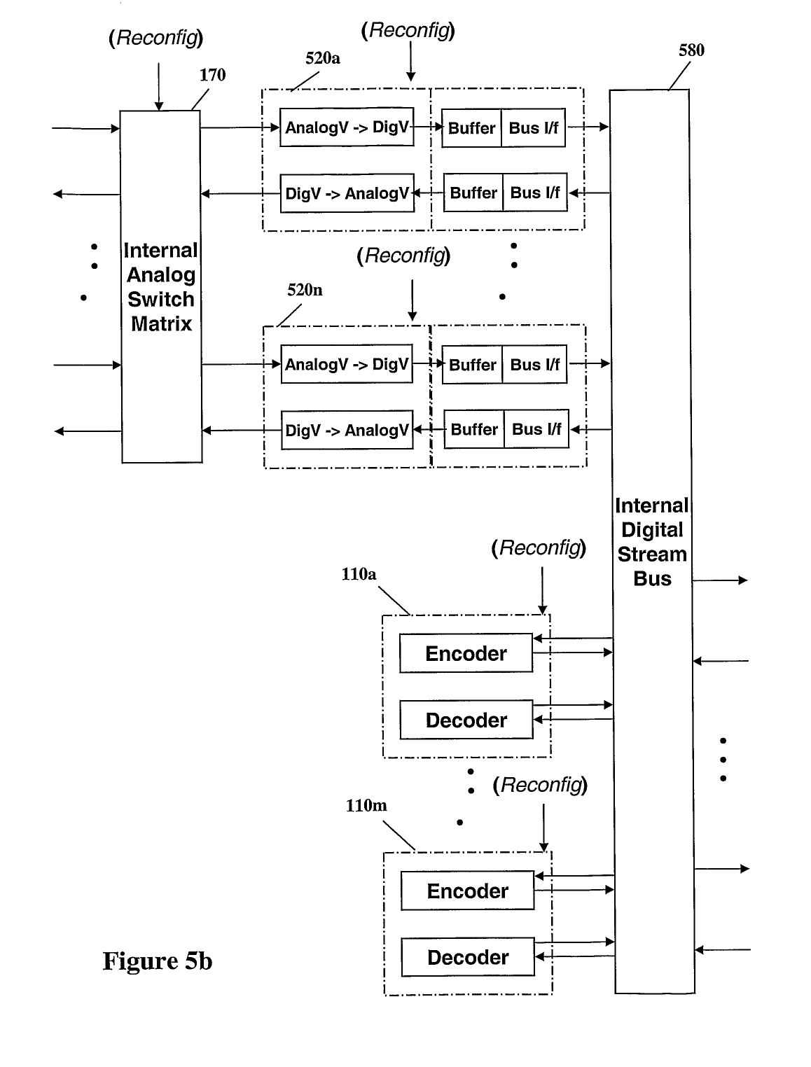

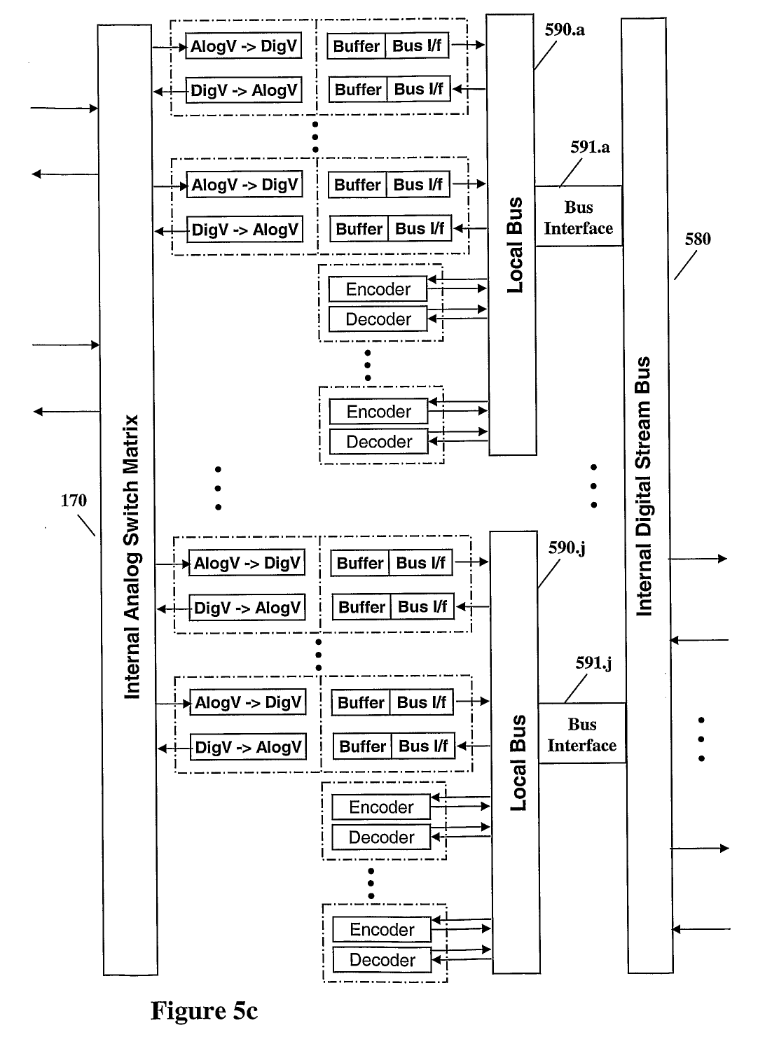

FIG. 5a illustrates the literal combination of FIGS. 3c and 4 together with FIGS. 2a-2b and switch reconfiguration capabilities. The result is a very flexible reconfigurable system that can perform a number of functions simultaneously as needed for one or more independent simultaneous sessions. Further, if the unbundled analog/digital conversation elements 120a-120n are fitted with buffers or a tightly-orchestrated multiplexing environment, a plurality of analog/digital conversation elements 120a-120n can be simultaneously assigned to a real-time media processor capable of implementing transparently interleaved multiple decode and/or multiple encode sessions on an as-needed or as-opportune basis.

The invention also provides for the incorporation or merging the Digital Bus or Matrix Switch 190 and the Internal Digital Stream Bus 180 into a common digital stream interconnection entity 580 as shown in FIG. 5b. For example, the common digital stream interconnection entity 580 can be a high-throughput digital bus such as a PCI bus, or beyond. For such an exemplary implementation, it is noted that some analog/digital conversation elements 520a-520n fitted with buffers and bus interfaces are readily commercially available in chip form (for example, the PCI bus compatible Phillips SAA7130/SAA7133/SAA7134™ video/audio decoder family). This type of interconnection approach allows individual real-time media processors to at any instant freely interconnect with:
The output of any other real-time media processor (for transcoding, to be discussed);
The input to one or more other real-time media processors (also for transcoding);
The output of any analog-to-digital conversation element;
The input to one or more digital-to-analog conversation elements;
An incoming data stream from the network;
One or more outgoing data streams to the network.

Such an arrangement clearly supports a wide range of time-varying demands for codec, transcoding, single-protocol broadcast, and multi-protocol broadcast services. The same arrangement can also implement additional services as will be discussed in Section 1.7. In such an arrangement where common digital stream interconnection entity 580 is used in this fashion (i.e., as in FIG. 5b), it is noted that there is a greater than 100:1 range of co-mingling data transfer rates:
A bidirectional uncompressed AV stream for full-screen full resolution video (i.e., CIF, or 640x480 pixel color image with 30 frame/sec frame rate) is typically 360 Mbps;
A unidirectional uncompressed AV stream for full-screen full resolution video (for example, 640x480) pixel color image at 25-30 frame/sec frame rate) is typically on the order of 150-200 Mbps;
A bidirectional uncompressed AV stream for quarter-screen full resolution video (i.e., a CIF 352x288 pixel color image at 25-30 frame/sec frame rate) is typically on the order of 80-100 Mbps;
A unidirectional uncompressed AV stream for quarter-screen full resolution video (i.e., a CIF 352x288 pixel color image at 25-30 frame/sec frame rate) is typically on the order of 40-50 Mbps;
A bidirectional compressed AV stream is typically on the order of 0.80 Mbps;
A unidirectional compressed AV stream is typically on the order of 0.35 Mbps.

Standard PCI bus implementations have been 32 bit wide and operate at 33-66 MHz in contemporary practice, so PCI bandwidth is roughly 1-2 GB/sec, supporting 5 to 11 unidirectional full-CIF flows or 2 to 5 bidirectional CIF sessions. Recent higher-bit rate 64-bit PCI/PCI-X extensions operate up to 32 Gbps, supporting up to sixteen times these upper limits (i.e., up to roughly 175 unidirectional full-CIF flows or 80 bidirectional CIF sessions). These relaxed limitations can be even further expanded by utilizing a plurality of PCI busses, each supporting a number of buffered analog/digital conversation elements 520a-520n and encoder/decoder pairs 110a-110m implemented via real-time media processors. Such segregating PCI busses may be linked by means of bus bridges. An example of such an arrangement is shown in FIG. 5c. Here a plurality of k instances of the FIG. 5b configuration of analog/digital conversation elements 520a-520n and real-time media processors (implementing encoder/decoder pairs) 110a-110m each have a dedicated bus 590a-590k and an associated bus bridge 591.a-591.j linking each dedicated bus 590a-590k with the internal digital stream bus 580.

### 1.3 Transcoding Support Via Capabilities Developed Thus Far

In the context of this invention, transcoding refers to a real-time transformation from one (video) coding (and compression) scheme to another. For example, a live video conferencing stream encoded via H.263 may be converted into MPEG 2 streaming video, or a proprietary video encoding method using run-length encoding may be converted to H.264, etc. These would be accomplished by the invention by in one manner or another connecting a decoder (configured to decode and decompress according to one encoding and compression scheme) to an encoder (configured to encode and compress according to another scheme), where each uses a different compression protocol. The invention can provide for such a capability in a number of ways. Illustrating a first approach, FIG. 6a shows how the internal digital bus or matrix switch 190 can provide a path 601 to connect a decoder from one of the encoder/decoder pairs 110a-110n to an encoder of a second from the encoder/decoder pairs 110a-110n. This is useful in general cases and essential for the cases where each of the encoder/decoder pairs 110a-110n are hard-dedicated to a particular compression scheme or limited set of compression schemes. In a second approach where the encoder of a selected one of the encoder/decoder pairs 110a-110n can execute a different compression scheme than that of the associated decoder in the encoder/decoder pair, the digital bus or matrix switch 190 can provide a path 602 to connect these, as shown in FIG. 6b, or if so provisioned the selected encoder/decoder pair from the collection of encoder/decoder pairs 110a-110n can provide an internal connection 603 for transcoding purposes.

It is also noted that the transcoding paths 601, 602, 603 described above are also useful as loopback paths for diagnostics purposes.

Additionally, a decoded signal from one of a plurality of decoders is fed to encoders through the internal digital bus or switch matrix 190 as shown in FIG. 6c. This provides transcoding of the same signal into a plurality of formats simultaneously. If the processor handling the decoding has enough capacity to also execute an encoding session, and additional simultaneous transcoding operation can be performed as shown in FIG. 6d.

### 1.4 Reconfigurations Via Unbundling of Bidirectional Compression and Mixed-Session Execution on a Given Media Signal Processor

With exemplary hardware environments provided for by the invention established, attention is now directed towards obtaining even further reconfigurable flexibility, giving rise to yet more new systems level functions, by unbundling the encoder/decoder pairs 110a-110n into encoder algorithms, decoder algorithms, and processors which may freely execute one, or concurrently more than one, instances of these algorithms simultaneously.

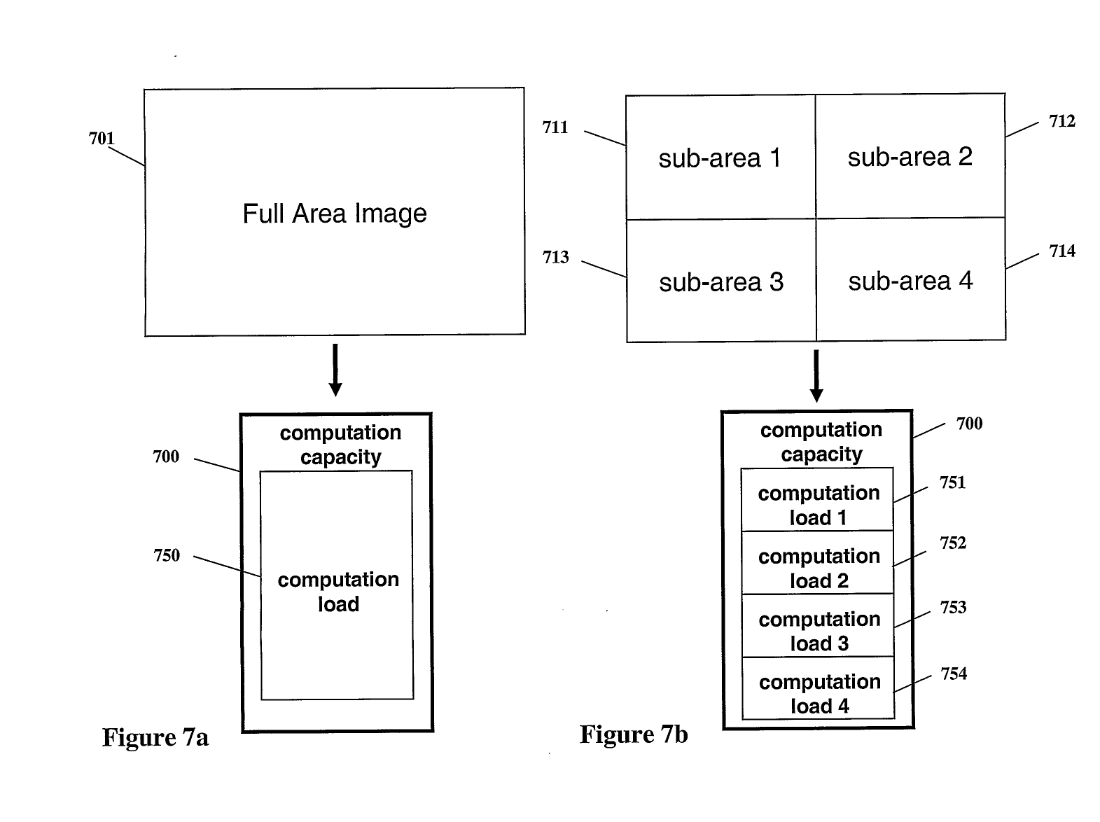

Modern high-performance “media” signal processing chips, such as the Equator BSP-15 or Texas Instruments C6000, are capable of concurrently executing an encoding algorithm and a decoding algorithm simultaneously, each at the level of complexity of a bidirectional 768 Kbps H.263 or 2 Mbps MPEG stream. Although some overhead is involved, for a fixed resolution, quantization level, motion-compensation quality-level, and frame-rate the computational load increases roughly linearly with image area. By way of illustration, FIG. 7a illustrates an “instantaneous” computational load 750, associated with a full-screen 701 encoding or decoding task, residing within an allotted computational capacity 700 provided for the real-time execution of the encoding or decoding task. FIG. 7b shows four smaller computational loads 751, 752, 753, 754, each respectively associated with an instance of an encoding or decoding task corresponding to the four partitions 711, 712, 713, 714 of the same image area 701. In comparing, the sum of the four computational loads 751, 752, 753, 754 (corresponding to the partitioned image areas 711, 712, 713, 714 of the same total image area 701) is depicted as being only slightly larger than the computational load 750 (corresponding to the unpartitioned image area 701). This situation, for example, corresponds to the loading of CIF versus QCIF encoding or decoding operations. In rough metrics the real-time computational loads for these tasks may be compared as follows:
QCIF decoding (QD): 1 load unit;
Full CIF decoding (FD): ˜4 load units;
QCIF encoding (QE): ˜4 load units;
Full CIF encoding (FE): ˜16 load units.

A contemporary media processor, such as the Equator BSP-15™ or Texas Instruments C6000™, can concurrently perform a CIF encode and decode, corresponding to 20 of the load units cited above. The same media processor then can alternatively perform, for example, any of the following simultaneous combinations:
One Full CIF encoding (FE) together with one QCIF encoding (QE) sessions;
One QCIF encoding (QE) together with four Full CIF decoding (FD) sessions;
Four QCIF decoding (QD) together with four Full CIF decoding (FD) sessions;
Twenty QCIF decoding (QD) sessions;
etc., or any other combination (QD, CD, QE, FE) satisfying an overall proportion-of-demand resource constraint similar to:

16FE+4FD+4QE+QD≦20

As DSP media processors become faster, the right-hand-side increases in magnitude, increasing the flexibility and capabilities of the overall system. Similarly, as algorithms become more efficient, the numbers on the left-hand-side of the constraint equations become smaller, also increasing the flexibility and capabilities of the overall system.

This kind of flexible real-time concurrent task computation arrangement subject to this sort of overall proportion-of-demand resource constraint can readily be extended to other combinations of tasks, types of tasks, task resource requirements, etc.

### 1.5 Mixed Task and Resource Allocation is a Highly-Reconfigurable Real-Time Signal-Processing Environment

For example, in an exemplary embodiment of the inventive concept, at least two types of sessions are supported, each drawing from a common collection or pool of shared resources with different requirements. Each type of session may utilize a differing formally defined service, or may involve differing ad-hoc type (or even collection) of tasks. To understand and design such a system with good performance and relatively high utilization of expensive resources, the common collection or pool of shared resources may be thought of at any moment as being divided into those resources allocated to a first type of session/service/task, those resources allocated to a second type of session/service/task, and those resources not currently allocated. One useful way of doing this so as to facilitate practical calculation is to represent the current number of active sessions in a geometric arrangement, each type on an individual mutually-orthogonal axis, and represent resource limitations by boundaries defining the most extreme permissible numbers of each type of session/service/task that are simultaneously possible with the resource limitations.

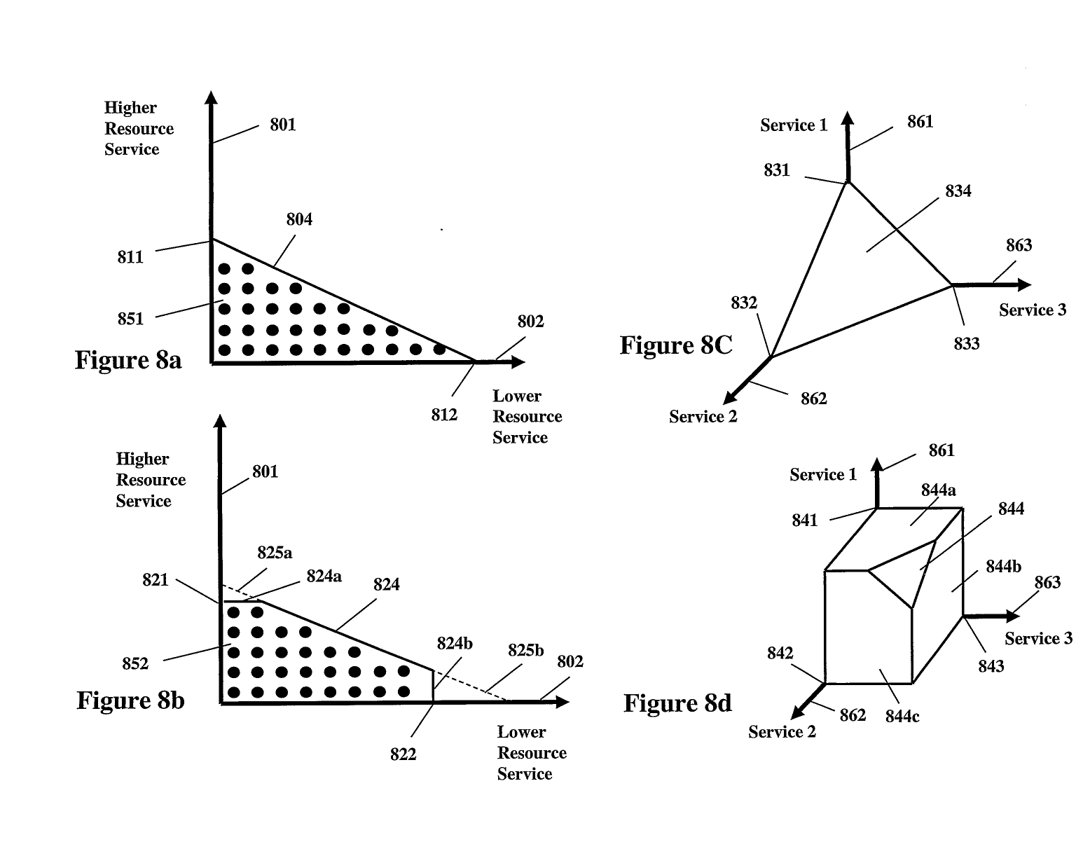

FIG. 8a illustrates a such geometric representation for the sharing of computation resources between two types of sessions, services, tasks, or collections of tasks whose resource requirements are roughly in a 2:1 ratio. This two-axis plot, as depicted, comprises a vertical axis 801 measuring the number of simultaneously active service sessions requiring the higher number of shared resources and a horizontal axis 802 measuring the number of simultaneously active service sessions requiring the lower number of shared resources. In this example the “higher resource service” associated with the vertical axis 801 requires approximately twice as many instances of real-time resource as the “lower resource service” associated with the horizontal axis 802. As, in this representation, the sessions require integer-valued numbers of the shared computational resource the resulting possible states are shown as the lattice of dots 851 inclusively bounded by the axes 801, 802 (where one or the other services has zero active sessions) and the constraint boundary 804 on the total number of simultaneously available units of resource (here, units of simultaneous real-time computation power). As the “higher resource service” associated with the vertical axis 801 requires approximately twice as many instances of real-time resource as the “lower resource service” associated with the horizontal axis 802, the constraint boundary 804 would be of the form:

2Y+X≦C

wherein the constraint boundary 804 intersects the horizontal axis 802 at the value X=C (i.e., the system is serving C sessions of the “lower resource service”) and also intersects the vertical axis 801 at the value Y=C/2 (i.e., the system is serving C/2 sessions of the “higher resource service”). If, instead, an instance of the “higher resource service” required four times as much real-time computational resource as the “lower resource service,” the constraint boundary 804 would be of the form:

4Y+X≦C;

If it used eight times as much, the constraint boundary 804 would be of the form:

8Y+X≦C,

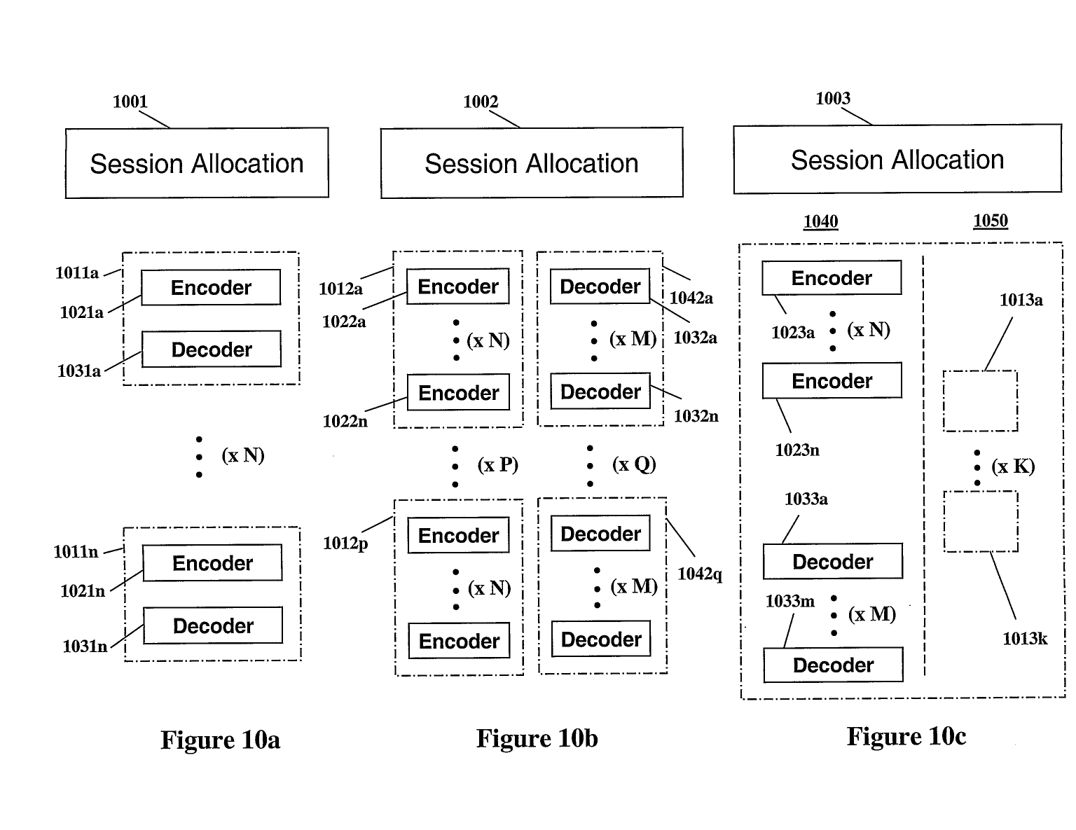

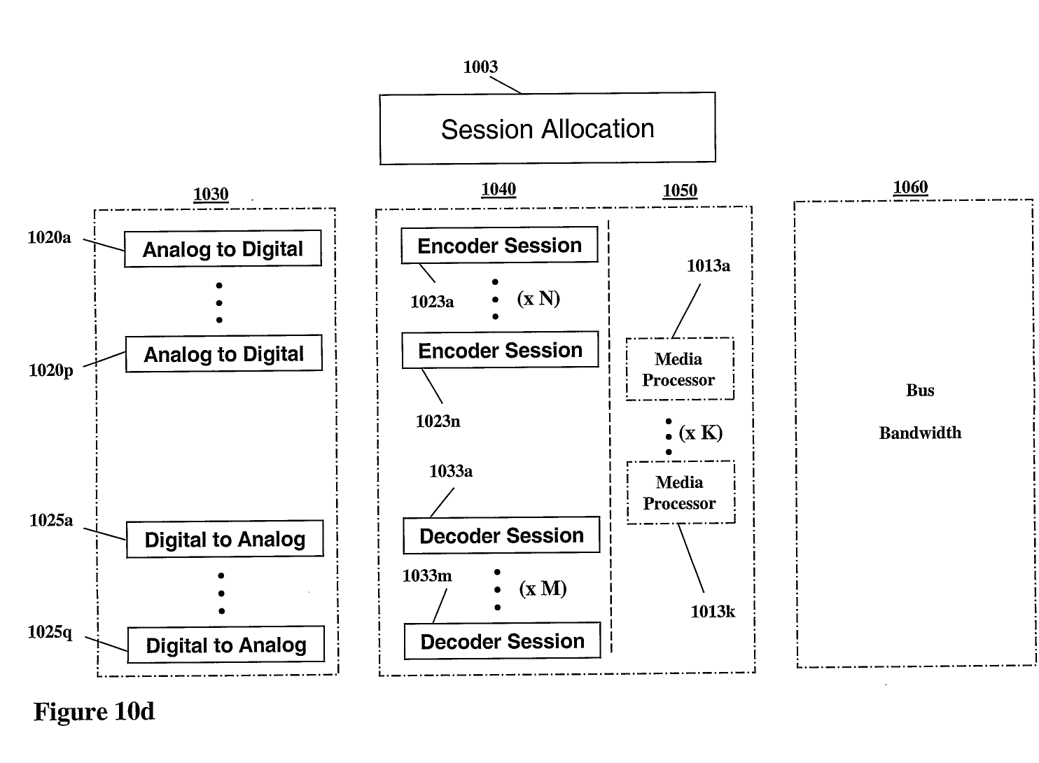

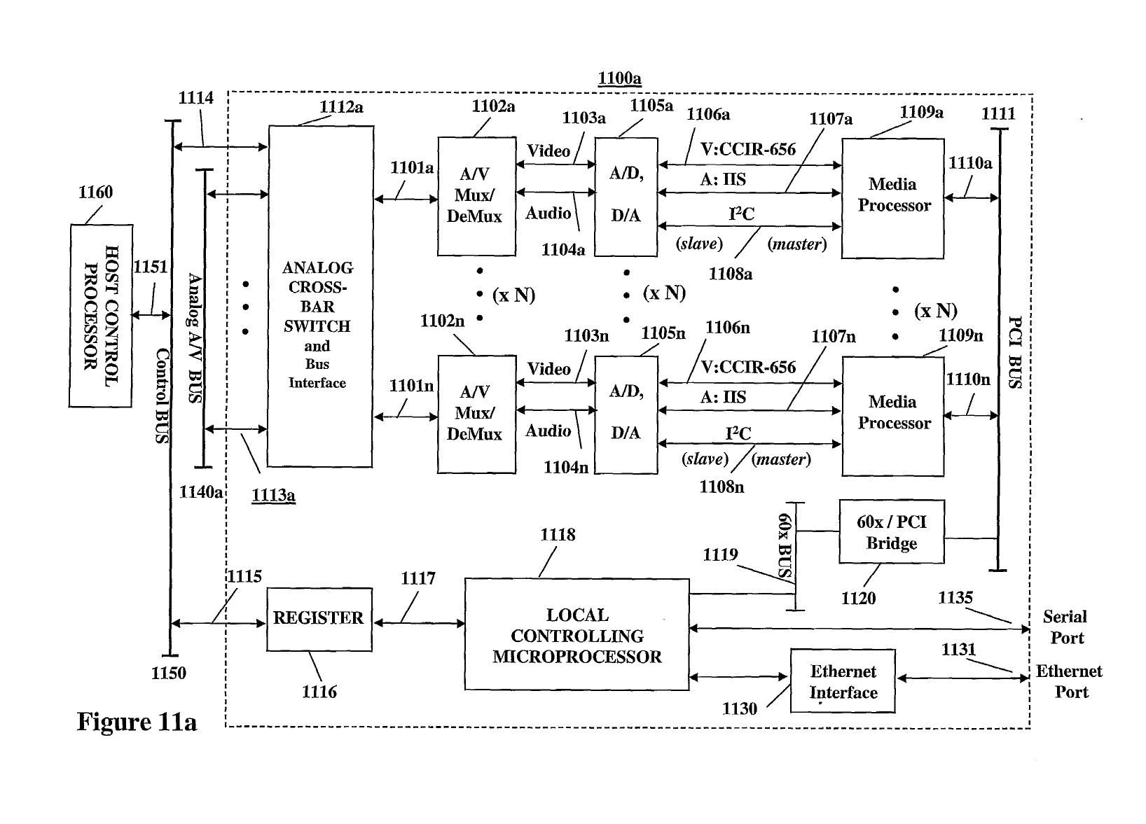

etc., i.e. the slope of the constraint boundary 804 gets increasingly less steep. One of the results of this ‘open’ policy is that services requiring higher numbers of shared resource experience statistically higher blocking (resource unavailability) than services requiring lower numbers of shared resource. This is because, using the last example, two higher resource sessions require 16 units of resource and if there are more than four lower resource sessions active, less than 16 units of resource would be available. The general phenomenon is suggested by FIG. 10, generalized from the blocking chart produced by Lyndon Ong included in L. Ludwig, “Adaptive Links,” Proceedings of the Sixth International Conference on Computer Communications, London, Sep. 7-10, 1982. Details depend on relative service request intensities for each type of service, some of the details of probability distributions assumed for arrival and holding times, etc.

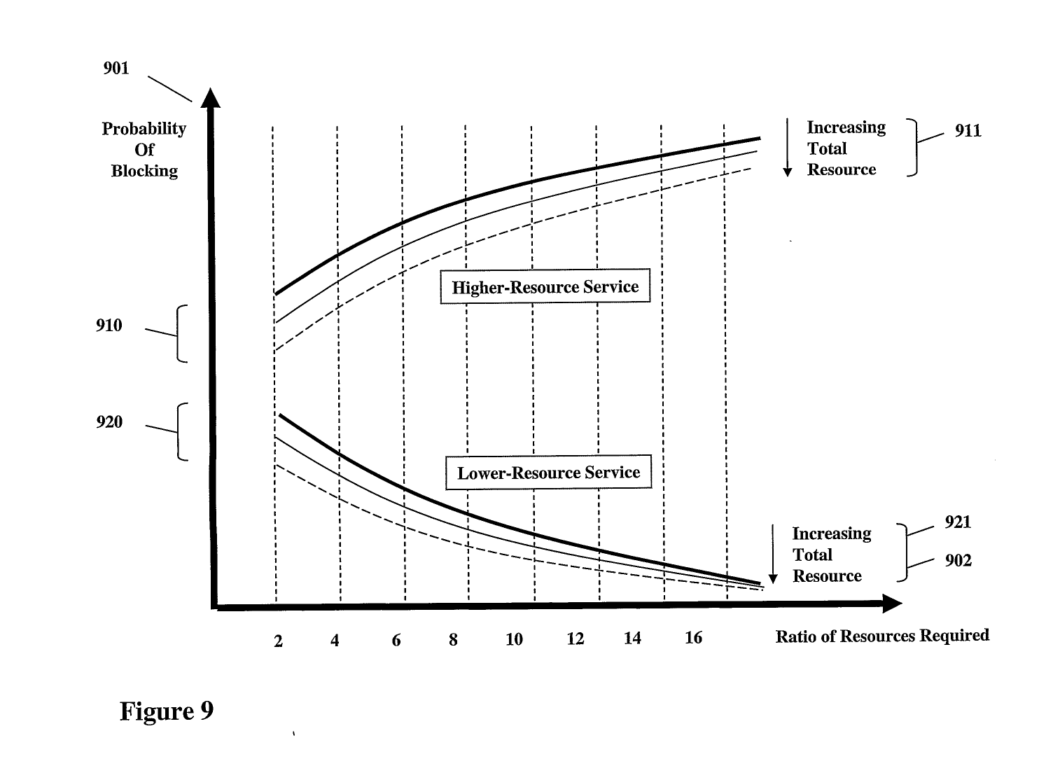

The general mathematics for specific computations for cases with ‘time-reversible’ (i.e., self-adjoint) stochastic dynamics (which include standard Erlang and Engset blocking models, typically directly relevant here) is given by J. S. Kaufman “Blocking in a Shared Resource Environment, IEEE Transactions on Communications, Vol COM-29 (10), 1474-1481, among many others. Although there are notable curve variations as well as pathologies and exceptions, FIG. 9 illustrates some essential behaviors and their general structure for non-extreme ranges of parameters. Families of blocking probability curves are shown for the “higher-resource service” 910 and “lower-resource service” 920. For each family of curves, the blocking probability 901 decreases 911, 912 with increasing numbers of total shared resource, as is almost always the case in shared resource environments. However, the two families of curves 910, 920 spread with increasing divergence as the ratio 902 of resource required increases, showing an increasingly unfair advantage afforded to the “lower-resource service.” One way to make allocations and denials fairer, and in general have more predictable operation, is to impose reservations, i.e., limit the number of resources that may be monopolized by any one service in the system. FIG. 8b illustrates the afore described exemplary system modified to include reservations. The constraint boundary 804 for the ‘open’ policy associated with FIG. 8a has been replaced with a reservation boundary 824, 824a, 824b truncating the states permitted by the original end-regions 825a, 825b associated with the ‘open’ policy with the reservation boundaries 824a, 824b corresponding to reservation levels 821, 822. These truncating reservation levels are dictated by the reservation constraints:

2Y≦Ymax (for Y boundary 825a at intercept 821);

8X≦Xmax (for X boundary 825b at intercept 822).

These reservation constraints can be calculated from algebraic equations resulting from various fairness policies. This results in a non-triangular region of permissible states 852. The reservation constraints for the exemplary two-service case of FIG. 8b are relatively minor; more severe reservation effects will be seen in FIG. 8d, to be discussed. In particular, FIG. 8c illustrates a generalization of FIG. 8a for a situation where there is a third service. Here the region of permissible states for an ‘open’ allocation policy (i.e., without reservations) takes the form of a three-dimensional simplex with intercepts 831, 832, 833 respectively with the now three “service instance count” axes 861, 862, 863. FIG. 8d shows the effect of reservations cutting off large portions of the open surface 834 of the geometric simplex, resulting in truncation planes 844a, 844b, 844c with intercepts 841, 842, 843. In this example, the reservations are so significant that only a small portion 844 of the original open surface 834 of the geometric simplex remains. In the limit, more stringent reservations would effectively eliminate resource sharing, transforming the region of permissible states into a cube whose outward vertex shares only one point with the original open surface 834 of the simplex.

These general resource allocation structures provide a basis for informed design of embodiments of the invention whose potential flexibility adds predictable value;
These types of analyses, and associated analytical metrics (blocking, utilization) that may be applied to them, can be used to characterize obtainable additional value when other types of real-time tasks are included, generalized, and made operative in the shared resource environment provided for by the invention;
Equally importantly, these metrics are useful in design engineering so as to ensure that intended flexibility may indeed be realizable in a final implementation. As more types of real-time tasks are included, generalized, and made operative in the shared resource environment made possible by the invention, additional opportunities for bottlenecks and other limitations are introduced. Limited implementation design vision may neglect the limitations of the number of instances of some types of specialized hardware (for example, I/O channels) in comparison to the considerations of other aspects (such as real-time computational throughput), resulting in an otherwise unforeseen performance or utilization bottlenecks;
Analytical models employing these metrics can be used to study ranges of traffic scenarios comprising various mixtures and volumes of differing configuration requests and durations so as to identify relative levels of utilization and blocking, thus enabling more cost-effective tuning of the relative quantities of various types of shared resources provided in an implementation.

FIGS. 10a-10d illustrate increasing degrees of unbundling of functionality components and making flexible allocations of the resulting unbundled processes and hardware resources. FIG. 10a illustrates the initially described environment where each processor 1011a-1011n runs exactly one encoding process 1021a-1021n and one decoding process 1031a-1031n and which are allocated, by a basic session allocation mechanism 1001, to granted session requests as bundled encoder/decoder process pair tying up one entire processor of the N processors 1011a-1011n. Within this arrangement, individual types of encoder/decoder algorithms and custom parameter settings may be incorporated to serve diverse needs in such cases where encoding and decoding are almost always needed as a bundled pair. The processors 1011a-1011n could be dedicated algorithm VLSI processors, more flexible reprogrammable media processors such as the Equator BSP-15, or general signal processors such as the Texas Instruments C6000.

FIG. 10b shows an unbundled approach where multiple encoder sessions 1022a-1022n, etc. run on a more specialized class of processor 1012a-1012p optimized for encoding while multiple decoder sessions 1032a-1032m, etc. run on a more general class of processor 1042a-1042q as decoding is typically a less-demanding task than encoding. Allocations are made by session allocation mechanism 1002. FIG. 10c illustrates a third environment where encode sessions 1023a-1023n and decode sessions 1033a-1033m freely run on any of a common class of processor 1013a-1013k as allocated by associated session allocation mechanism 1003. It is noted that hybrids of FIGS. 10b and 10c are also possible, allowing decoding sessions to run on encoder-capable processors or decoder-only processors employing only a slightly more involved session allocation mechanism.

FIG. 10d shows the processing environment of FIG. 10c expanded to include allocation considerations for an unbundled collection 1030 of analog/digital conversation elements and bus bandwidth 1060 for interconnecting the media processors 1050 with I/O channels and one another. The unbundled collection 1030 of analog/digital conversation elements comprises a number of analog-to-digital conversion elements 1020a-1020p and a perhaps different number of digital-to-analog conversion elements 1025a-1025q. Also, as will be discussed, network protocol processing may partitioned into separated parts so that one part may execute on a real-time media processor and the other part execute on the local controlling processor 105. In such an arrangement, the Session Allocation element 1003 now presides over the following collection of more generalized “resources:”
Non-shared hardware elements:
   analog-to-digital conversion elements 1020a-1020p;
   digital-to-analog conversion elements 1025a-1025q;
Shared hardware elements:
   shared bus 1060 bandwidth;
   real-time media processor elements 1050;
   shared network-port bandwidth (not explicitly depicted);
Media processing algorithms:
   encoder 1023a-1023n;
   decoder 1033a-1033m;
Network protocol processing algorithms:
   lower level (not explicitly depicted);
   higher level (not explicitly depicted).

### 1.6 Additional Types of Reconfiguration Capabilities

Reflecting the opportunities and concerns cited above, the invention also provides for further expanding the scope of hardware elements that are profitably manageable in flexible configurations;
As a first type of example, specialized networking and telecommunications interfaces, such as those for ISDN, Ethernet, T-1, etc., may be implemented in a manner where they may be shared by a plurality of media processors;
As a second type of example, more than one locally controlling processor may be used to provide additional session management, communications protocol rendering sessions, etc. This adds to the total processing power, but typically would require an allocated processing task to be indivisibly allocated to one of the processors (i.e., an encoder session must run within one processor, not split into fractional tasks across two or more processors);
Similarly, more than one internal data transfer fabric (internal bus, cross-bar switch, etc.) may be used to provide additional overall bandwidth, but typically would require an allocated processing task to be indivisibly allocated to one of these fabrics;
In the multiple data transfer fabric case just above, limited bandwidth trunking interconnection may be provided between the data transfer fabrics. The bandwidth though such limited bandwidth trunking interconnection is a third type of example.
Yet other shared and unshared items may also be added, for example dedicated network protocol processors, video-frame memory buffers, video processing elements or algorithms, audio processing elements or algorithms, etc.

In each of these cases, the multi-service allocation mechanisms described earlier, or extensions of them, may be used to manage resources according to various allocation policies. Typically allocation policies determine the bounding convex hull (edges and surfaces 804, 824, 824a, 824b, 834, 844, 844a-844c as shown in FIGS. 8a-8d, and their higher dimensional extensions) of the permissible states.

### 1.7 Additional Applications

In addition to analog-to-digital/encoding sessions, decoding/digital-to-analog sessions, and transcoding sessions, the invention provides a valuable substrate for the support of other types of functions and operations.

A first example of additional capabilities provided for by the invention is an MCU function, useful in multi-party conferencing and the recording of even two-party video calls. As another example, a video storage and playback encode/decode/transcode engine is illustrated, malting use of the invention's encoder, decoder, and transcode capabilities in conjunction with a high-throughput storage server.

1.7.1 Continuous Presence MCU Applications

The invention provides for using the system to be configured so as to implement an MCU function, useful in multi-party conferencing and the recording of even two-party video calls. This configuration may be a preprogrammed configuration or configured “on-demand” in response to a service request from unallocated encoders and decoders.

It is noted that the topology of the multipoint connection and the associated functions the encoders and decoders are performing determine the source of the streams directed to the MCU functionality. For example:
Incoming analog streams directed to the system would need to be encoded to create the raw digital streams needed as input for the MCU function, so these signals would originate from encoders;
Incoming compressed digital streams would need to be decoded to create the raw digital streams needed as input for the MCU function, so these signals would originate from decoders.

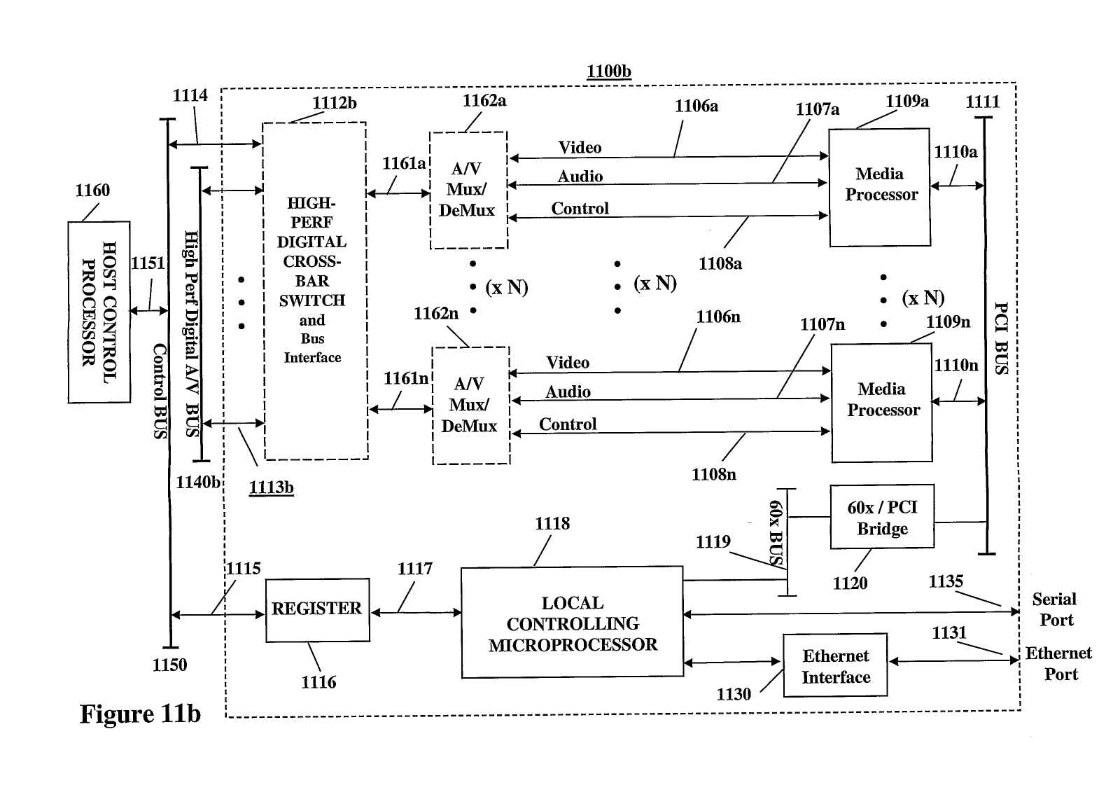

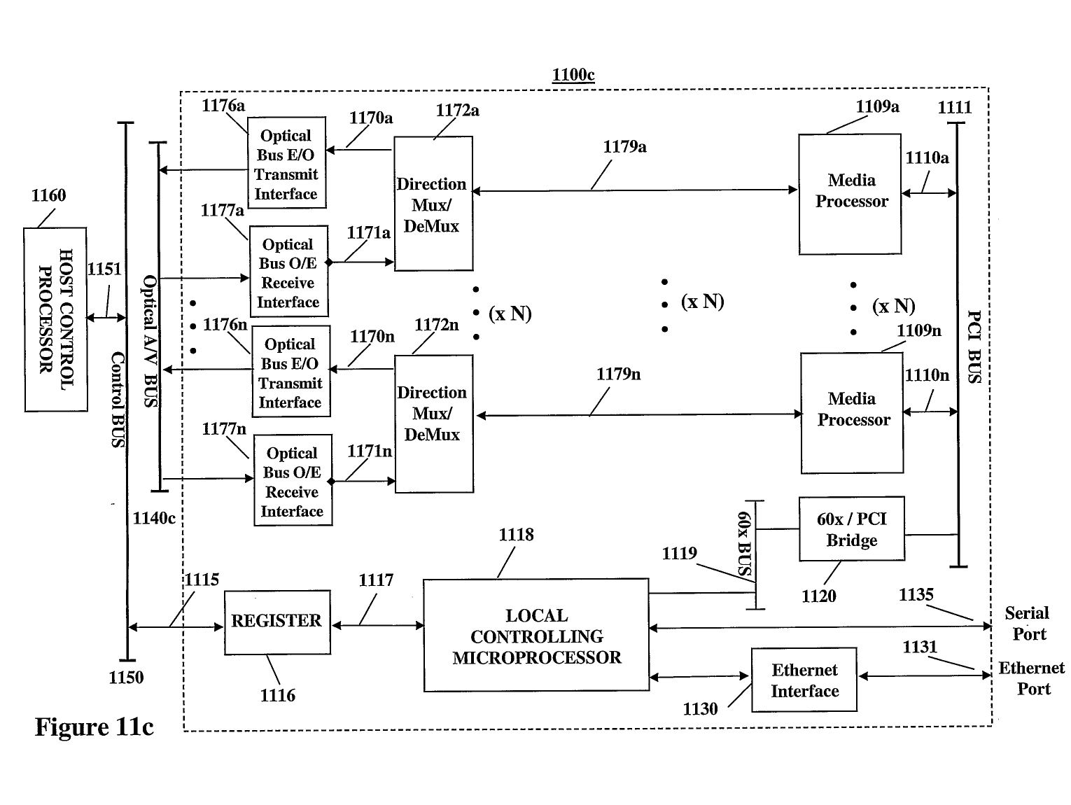

As to the range of MCU functionalities that can be realized, it is noted that contemporary MCUs implement one or more of a number of types of output streams:
1. A selected single incoming video stream, wherein the selection is controlled by a facilitator or other participant user interface;
2. A selected single incoming video stream, wherein the selection is controlled by detection of the most recent loudest speaker according to selection stabilizing filtering or temporal logic;
3. A “continuous presence” image assembled from a plurality of input streams into a mosaic with an appearance similar to that of the contiguous arrangement 711-714 in FIG. 7b. The selected input streams may be:
   a. All incoming streams in the multipoint video conference up to some maximum number;
   b. Selected incoming streams with one or more of the selections controlled by a facilitator or other participant user interface;
   c. Selected incoming streams with one or more of the selections controlled by detection of the last loudest speaker according to selection stabilizing filtering or temporal logic.
In the above, a single continuous presence image may be made available for all conference participants, or separate ones may be made for individual conference participants.
These may be implemented in a variety of ways, including:
Type 1 capabilities may be readily implemented by malting bus of switching selections for the outgoing streams within FIG. 5a elements 170, 180, and/or 190. The selections are controlled, through user interface software, directly by one or more user interface commands. Should the various endpoints comprise a plurality of signal formats, the resulting routing of signals will typically at least at times involve transcoding configurations (such as that of FIG. 6a, although in general elements other than 190 may equally do the signal routing);
Type 2 capabilities may be implemented with many aspects of Type 1 but with the further (or alternative) provision of speech activity detection and selection stabilizing employing filtering or temporal logic. The speech activity detection is readily and naturally implemented in the audio routines of the decoders and encoders, the choice of which depends on the topology of the multipoint connection and the associated functions the encoders and decoders are performing. For example, local analog streams directed to the system would in most cases would most effectively support speech detection in the encoders, while incoming digital streams would in most cases most effectively detect speech in the decoders. The selection stabilizing filtering or temporal logic could be provided by the local controlling processor (i.e., 151 in FIG. 1b or 1118 in FIGS. 11a-11c, to be discussed);
Broadly, the overall Type 3 “continuous presence” capabilities may be realized in at least these ways:
   Sending all selected incoming streams full bandwidth to the given endpoint, thus relying on the endpoint to assemble or otherwise display and mix, respectively, the selected video and audio streams;
   Sending all selected incoming streams at reduced bandwidth to the given endpoint, thus relying on the endpoint to assemble or otherwise display and mix, respectively, the selected video and audio streams. For example, transcoding between CIF and QCIF formats can readily be provided by the invention;
   Decoding and mixing selected incoming audio streams can readily be provided by the invention. Typically the mixing is a so-call “minus-one” mix where each user receives a mix of every audio stream except that user's own. Further, the audio mix often may include more incoming audio streams that the number of incoming video streams in the associated 3 “continuous presence” stream. The mixing can be done in an idle media processor, but in many cases can be done as part of an expanded encoder task: rather than simply encoding one audio stream, several audio streams may be presented to the encoder where they are mixed (and potentially processed dynamically for simple noise suppression, simple signal limiting, etc.) into a single stream which is then encoded;
   Creation of a continuous presence output stream within the system. This begins with reducing the resolution of the streams to be assembled into a continuous presence output stream. This may be done in a number of ways, including:
      Most directly, at the associated sources (decoders for compressed digital streams, encoders for analog streams) of the streams to be merged, as part of their function of those sources; or
      Less efficiently, at the entity (memory interface or processor) implementing the assembly of the continuous presence output stream; or
      Most ambitiously, by appropriately timed transfer operations among the sources of the streams to be merged and the entity implementing the assembly of the continuous presence output stream.
   With these aspects realized, the actual assembly of the continuous presence output stream can be obtained in any of the following ways:
      Least efficiently by directing the streams to be assembled to an additional processor configured for realizing an MCU function;
      With better efficiency, directing the streams to be assembled to a memory that is connected to the internal digital stream bus. The memory assembles the information representing an evolving continuous presence frame which periodically updated by the sources and periodically read by one or more encoder(s), each encoding an outgoing continuous presence output stream;
      With best efficiency (and most ambitiously), by appropriately timed transfer operations among the sources of the streams to be merged and one or more encoder(s), each encoding an outgoing continuous presence output stream. Here each encoder assembles the continuous presence stream ‘on-the-fly’ by ‘just-in-time’ delivery of streams from the sources.

In these, a local controlling processor is typically somewhat to heavily involved in coordinating the operations among the various encoders, decoders, and any other allocated entities.

1.7.2 Video Storage Applications

The invention provides for the system to be configured to implement a video storage and playback encode/decode/transcode engine. This makes use of encoder, decoder, and transcode capabilities in conjunction with a high I/O-throughput storage server. This configuration may be a preprogrammed configuration or configured on-demand in response to a service request involving unallocated encoders and decoders.

In one implementation, a high I/O-throughput storage server connects with the system through a network connection such as high-speed Ethernet. In another implementation, the system further comprises one or more disk interfaces such as IDE/ATA, ST-506, ESDI, SCSI, etc. Such a disk interface would connect with, for example, the internal digital stream bus. Other configurations are also possible.

There are several reasons for adding video storage capabilities and applications to certain implementations of the invention. These include:
The Natural role in recording of multipoint conferences utilizing an MCU function realized within the system;
Readily adapting the above MCU recording software and hardware infrastructure to also host point-to-point video call recording;
Readily adapting the above point-to-point video call recording software and hardware infrastructure to provide video call answering systems (greeting playback, message recording);
Utilizing the transcoding capabilities of the system for any needed or useful video signal format conversions when making a video recording;
Utilizing the transcoding capabilities of the system for any needed or useful video signal format conversions when playing back a stored video file. This includes the ability to multipoint-distribute or network-broadcast a given playback session in multiple video signal formats simultaneously;
Useful “smooth growth” and “multiple use” value in growing and evolving the size and functionality of a deployed implementation of the system;
Even further overall cost savings due to natural shared-resource utilization improvements resulting from Erlang/Engset stochastic behaviors as discussed in Section 1.5.

2. Example Implementations of the Invention

The discussion now turns to and some exemplary embodiments. Four general exemplary types are considered, distinguished by the type of bus interface technology provided by the hosting system:

Analog A/V bus (FIG. 1a);

High performance digital A/V bus for D1, D2, ATSC/8-VS B, etc. (FIG. 1b);

Optical A/V video bus (FIG. 11c).

The initial discussion is directed to the analog A/V bus case, and the others are then considered as variations. This is followed by a unified description of data flows and task management.

### 2.1 Exemplary Analog A/V Host Bus Implementation

FIG. 11a illustrates a high-level architecture for a single-card implementation 1100a suitable for interfacing with the backplane of a high-performance analog audio/video switch. Such a switch may be part of a networked video collaboration system, such as the Avistar AS2000, or part of a networked video production system, networked video broadcast system, networked video surveillance system, etc.

Referring to FIG. 11a, the system features a locally controlling processor 1118 which provides resource management, session management, and IP protocol services within the exemplary embodiment. As such, the locally controlling processor 1118, which for the sake of illustration may be a communications-oriented microprocessor such as a Motorola MPC 8260™, interconnects with the real-time media processors 1109a-1109n.

In this exemplary embodiment, the media processors are each assumed to be the Equator BSP-15 ™ or Texas Instruments C6000™ which natively include PCI bus support 1110a-1110n. Each of these communicate with the locally controlling processor 1118 by means of a fully implemented PCI bus 1111 linked via a 60x/PCI bus protocol bridge 1120, such as the Tundra Powerspan™ chip, to an abbreviated implementation of a “PowerPC” 60x bus 1119. It is noted that most contemporary signal processing chips capable of implementing real-time media processors 1109a-1109n natively support the PCI bus rather than directly usable with 60x bus 1119, so the use of a transparent bus protocol bridge 1120 as shown in FIG. 11a is a likely situation for this generation of technology.

The locally controlling processor 1118 provides higher-level packetization and IP protocol services for the input and output streams of each of the real-time media processors 1109a-1109n and directs these streams to and from an Ethernet port 1131 supported by an Ethernet interface subsystem 1130, such as the Kendin KS8737/PHY™ interface chip or equivalent discrete circuitry. Alternatively, other protocols, such as Firewire™, DS-X, Scramnet™, USB, SCSI-II, etc., may be used in place of Ethernet.

The locally controlling processor 1118 also most likely will communicate with the host system control bus 1150; in this exemplary embodiment a bus interface connection 1115 connects the host system control bus 1150 with a communications register 1116 which connects 1117 with the locally controlling processor 1118 and acts as an asynchronous buffer.

For diagnostics purposes, locally controlling processor 1118 may also provide a serial port 1135 interface. Alternatively, a wide range of other protocols, including USB, IEEE instrumentation bus or Centronix™ parallel port, may be employed.

Again referring to FIG. 11a, each of the real-time media processors 1109a-1109n connect with an associated analog-to-digital (A/D) and digital-to-analog (D/A) converters 1105a-1105n. Each of the analog-to-digital (A/D) and digital-to-analog (D/A) converters 1105a-1105n handle incoming and outgoing digital audio and video signals, thus providing four real-time elements for bidirectional audio signals and bidirectional video signals. The video A/D may be a chip such as the Phillips SAA7111™ and the video D/A may be a chip such as the Phillips SAA7121™, although other chips or circuitry may be used. The audio A/D may be, for example, the Crystal Semiconductor CS5331A™ and the audio D/A may be, for example, the Crystal Semiconductor CS4334™, although other chips or circuitry may be used.

The bidirectional digital video signals 1106a-1106n exchanged between the analog-to-digital (A/D) and digital-to-analog (D/A) converters 1105a-1105n and real-time media processors 1109a-1109n are carried in digital stream format, for example via the CCIR-656™ protocol although other signal formats may be employed. The bidirectional digital audio signals 1107a-1107n exchanged between the analog-to-digital (A/D) and digital-to-analog (D/A) converters 1105a-1105n and real-time media processors 1109a-1109n are also carried in digital stream format, for example via the IIS protocol although other signal formats may be employed.

Bidirectional control signals 1108a-1108n exchanged between the analog-to-digital (A/D) and digital-to-analog (D/A) converters 1105a-1105n and real-time media processors 1109a-1109n may be carried according to a control signal protocol and format, for example via the I²C protocol although others may be employed. In this exemplary embodiment, the real-time media processors 1109a-1109n serve in the “Master” role in the “master/slave” I²C protocol. In this way the media processors can control the sampling rate, resolution, color space, synchronization reconstruction, and other factors involved in the video and analog conversion.

Each of the analog-to-digital (A/D) and digital-to-analog (D/A) converters 1105a-1105n handles incoming and outgoing analog video signals 1103a-1103n and analog audio signals 1104a-1104n. These signals are exchanged with associated analog A/V multiplexers/demultiplexers 1102a-1102n. The incoming and outgoing analog video signals 1103a-1103n may be in or near a standardized analog format such as NTSC, PAL, or SECAM.

In this exemplary embodiment, the analog A/V multiplexers/demultiplexers 1102a-1102n exchange bidirectional multiplexed analog video signals 1101a-1101n with an analog crossbar switch 1112a that connects directly with an analog bus 1140a via an analog bus interface 1113a. In this exemplary embodiment, the analog crossbar switch 1112a is directly controlled by the host control processor 1160 via signals carried over the host system control bus 1150 and accessed by host system control bus interfaces 1151 and 1114. Alternatively, the analog crossbar switch 1112a, if one is included, may be controlled by the local controlling processor 1118 or may be under some form of shared control by both the host control processor 1160 and the local controlling processor 1118.

Internally, each of the analog A/V multiplexers/demultiplexers 1102a-1102n, should they be used in an implementation, may further comprise an A/V multiplexer (for converting an outgoing video signal and associated outgoing audio signal into an outgoing A/V signal) and an A/V demultiplexer (for converting an incoming A/V signal into incoming an video signal and associated incoming audio signal). Typically, the bidirectional paths 1101a-1101n comprise a separate analog interchange circuit in each direction. This directional separation provides for maximum flexibility in signal routing and minimal waste of resources in serving applications involving unidirectional signals. Alternatively, the two directions can be multiplexed together using analog bidirectional multiplexing techniques such as frequency division multiplexing, phase-division multiplexing, or analog time-division multiplexing. The host system, particularly the analog A/V bus 1140a, will typically need to match the chosen scheme used for handling signal direction separation or multiplexing. The invention also provides for other advantageous approaches to be used as is clear to one skilled in the art.

Returning to the transcoding configurations of FIG. 6, note that a media processor 1109a-1109n of FIG. 11a may internally implement the loopback path 603 shown in FIG. 6b. Thus any of the media processor 1109a-1109n of FIG. 11a may be configured to internally implement an entire transcoding function provided the media processor has enough computational capacity for the task. It is further noted that a media processor 1109a-1109n of FIG. 11a, when implemented with a flexible chip or subsystem such as the Equator BSP-15™ or Texas Instruments C6000™, may direct both its input and its output to the same pus, i.e., the PCI bus 1111 in FIG. 11a. Thus the loopback path 603 shown in FIG. 6b linking two separate media processors can be realized with the PCI bus 1111 in FIG. 11a with the overall input and output paths to the transcoder configuration also carried by the PCI bus 1111. This permits transcoding tasks whose combined decoding/encoding load exceeds the capacity of a single media processor 1109a-1109n.

The latter configuration can be exploited further by routing a decoded signal into a plurality of decoders as shown in FIGS. 6c and 6d. This provides transcoding of the same signal into a plurality of formats simultaneously.

It is further noted that many or in fact all of the transcoding streams may be routed through the networking port 1131. If more bandwidth is required the network protocol processing path (here involving the bus bridge 1120, the local controlling microprocessor 1118) can be re-architected to provide dedicated high-performance protocol processing hardware.

### 2.2 Exemplary High Performance Digital A/V Host Bus Implementation

Although an interface for an analog A/V bus is described above, the core architecture is essentially identical for a raw high-performance digital stream such as the D1 and D2 formats used in digital video production, ATSC/8-VS B, etc. FIG. 11b shows an exemplary embodiment adapting the basic design of FIG. 11a to use with such high-performance digital streams. The busses of hosts for such systems are often time-division multiplexed or provide space-divided channels. In this fashion, there are deeper architectural parallels between such a system and one designed for hosts with analog A/V busses.

For a high-performance digital stream host bus implementation, the analog-to-digital (A/D) and digital-to-analog (D/A) converters 1105a-1105n are omitted and the analog bus 1140a and analog bus interface 1113a are replaced by their high-throughput digital counterparts 1140b and 1113b. The analog crossbar switch 1112a and analog A/V multiplexers/demultiplexers 1102a-1102n could be omitted altogether, or replaced by their high-throughput digital counterparts 1112b and 1162a-1162n as shown in the figure. Here, the bidirectional video 1106a-1106n, audio 1107a-1107n, and control 1108a-1108n paths connect directly to these optional high-throughput digital A/V multiplexers/demultiplexers 1162a-1162n. Alternatively, the media processors 1109a-1109n could do the optional A/V stream multiplexing/demultiplexing internally. The high-throughput multiplexed digital A/V signals 1162a-1162n can either be directed to an optional high-throughput digital crossbar switch 1112b as shown or else connect to the high-throughput digital A/V bus 1140b. Such busses are typically time-division multiplexed, but in the case they are not either time-division-multiplexed or provide space-divided channels, additional bus arbitration hardware would be required. If the optional high-throughput digital crossbar switch 1112b is used, it connects to the high-throughput digital A/V bus 1140b. Otherwise the operation is similar or identical to that of the analog I/O bus implementation described in Section 2.1.

### 2.3 Exemplary Optical A/V Host Bus Implementation

The exemplary high-level architecture of FIG. 11a also is readily adapted to an optical host bus. For such an implementation, the analog aspects of the analog-to-digital (A/D) converters, digital-to-analog (D/A) converters, analog bus interface, analog bus crossbar switching, and analog A/V multiplexers/demultiplexers depicted in FIG. 11a would be replaced by their optical technology counterparts. Similarly, the host system need not be a switch but could readily be another type of system such as videoconference bridge or surveillance switch mainframe.

FIG. 11c shows an exemplary embodiment adapting the basic design of FIG. 11a to use with optical interface signals. In this exemplary implementation the media processors 1109a-1109n do the optional A/V stream multiplexing/demultiplexing internally, and directional multiplexers/demultiplexers 1172a-1172n provide directional signal separation into bus transmit 1170a-1170n and bus receive 1171a-1171n electrical signal paths. These are converted between electrical and optical paths by means of bus transmitters 1176a-1176n and bus receivers 1177a-1177n which exchange optical signals with the bus. Otherwise the operation is similar or identical to that of the analog I/O bus implementation described in Section 2.1. Note a crossbar switch, akin to 1112a in FIG. 11a and 1112b in FIG. 11b, may also be inserted in this signal flow, either in the directionally multiplexed electrical paths 1179a-1179n, the directionally separated electrical paths 1170a-1170n and 1171a-1171n, or the directionally separated optical paths connecting directly with the optical bus 1140c.

### 2.4 Exemplary Task-Oriented Signal Flow

Here two exemplary signal flows for codec and transcoding functions are provided. In these, configurations and routing involved in moving the analog signals to and from the host system bus 1140a through the analog crossbar switch 1112a and the digital signals to and from the network port 1131 through the PCI bus 1111 and other subsystems 1120, 1118, 1130 are not depicted.

2.4.1 Bidirectional Codec Example

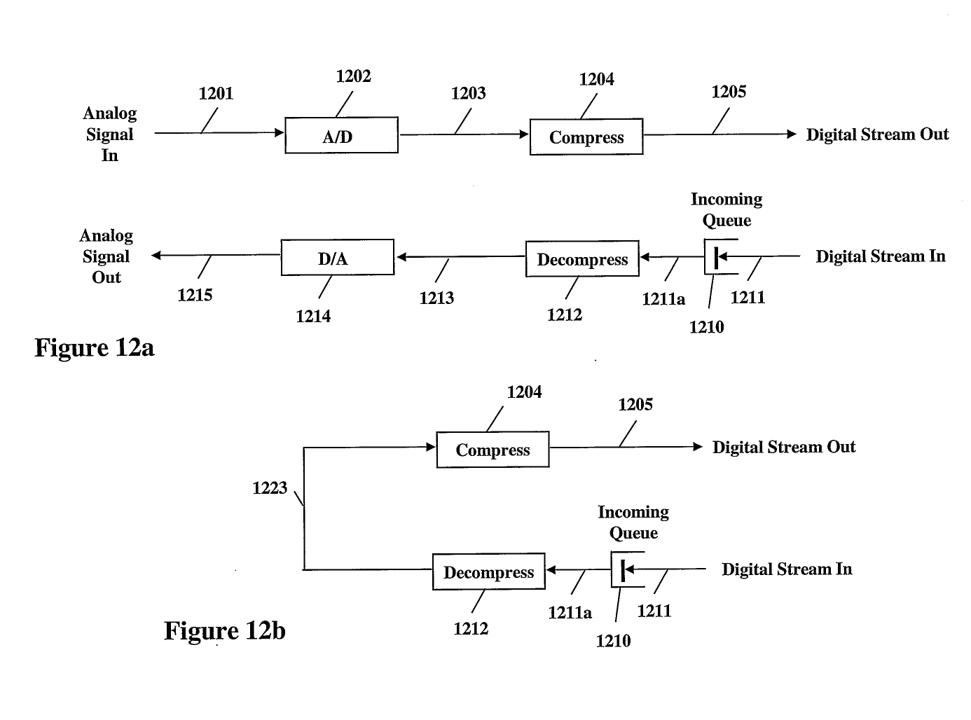

FIG. 12a illustrates an exemplary signal flow for a bidirectional codec (two-way analog compression/decompression) operation using the system depicted in FIG. 11a as provided for by the invention. This exemplary signal flow could readily be executed in the parallelized multi-task environment of the exemplary embodiment depicted in FIG. 11a. This procedure has two co-executing signal paths. In the first of these, an incoming analog signal pair 1201 is transformed into a wideband digital format 1203 by an A/D converter 1202 which is then compressed in a compression step 1204 to create an outgoing digital stream 1205. In the other of these, an incoming digital stream 1211 is queued in a staging operation 1210 for at least asynchronous/synchronous conversion (if not also dejittering) and then provided in a statistically-smoothed steady synchronous stream 1211a to a decompression operation 1212 to create a wideband digital signal 1213 that is transformed by a D/A converter 1214 into an outgoing analog signal 1215. Additional configurations and routing involved in moving the analog signals to and from the host system bus 1140a through the analog crossbar switch 1112a and the digital signals to and from the network port 1131 through the PCI bus 1111 and other subsystems 1120, 1118, 1130 are not depicted. The compression operation 1204 and decompression operation 1212 may be executed on the same media processor or separate media processors from the collection 1109a-1109n.

2.4.2 Transcoding Example

FIG. 12b illustrates an exemplary signal flow for a unidirectional transcoding operation. an incoming digital stream 1211 is queued in a queuing operation 1210 for dejittering and then provided in a statistically-smoothed steady stream 1211a to a decompression operation 1212 to create a wideband digital signal 1223. This wideband digital signal 1223 is then encoded into a different signal format in a compression step 1204 to create an outgoing digital stream 1205.

### 2.5 Modularization of Lower Level Tasks for Rapid Reconfiguration

Although not required in many embodiments, it can be advantageous for the exemplary lower-level tasks and operations depicted above to be aggregated to form higher-level steps and operations. In various implementations this allows for useful modularity, better software structure, and better matching to a generalized operational framework.

In particular, in situations where multiple types of compression or decompression algorithms co-execute on the same media processor this would provide ready and rapid reconfigurable support for multiple types of protocols in a common execution environment. This includes self contained means, or other standardized handling, for initiation, resource operation, resource release, and clean-up.

Such modularization allows for rapid reconfiguration as needed for larger network applications settings. In cases with explicit control of network elements, such as the AvistarVOS™, the system can natively reconfigure ‘on demand.’ In more primitive or autonomous network configurations, the invention provides for the system to rapidly reconfigure ‘behind the scenes’ so as to flexibly respond to a wide range of requests on-demand.

### 2.6 Exemplary Task Management

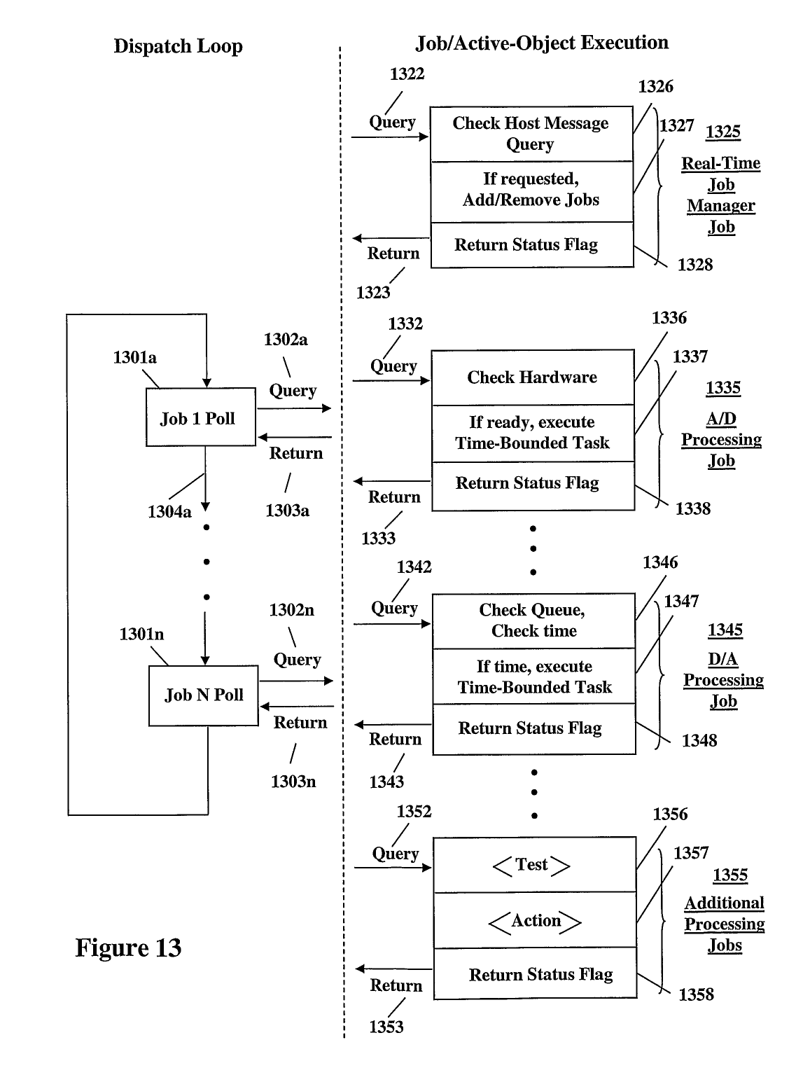

FIG. 13 illustrates an exemplary real-time process management environment, provided within the media processors, which adaptively support a plurality of real-time jobs or active objects within the exemplary systems depicted in FIGS. 11a-11c. This exemplary real-time process management environment comprises a real-time job manager, a dispatch loop, and a job/active object execution environment. It is understood that many other implementation approaches are possible, as would be clear to one skilled in the art.

The real-time job manager manages the execution of all other real-time jobs or active objects. It can itself be a co-executed real-time job or active object, as will be described below. The real-time job manager accepts, and in more sophisticated implementations also selectively rejects, job initiation requests. Should job request compliance not be handled externally, it may include capabilities that evaluate the request with respect to remaining available resources and pertinent allocation policies as discussed in Section 1.5. The jobs themselves are best handled if modularized into a somewhat standardized form as described in Section 2.5.

The left portion of FIG. 13 illustrates an exemplary real-time dispatch loop adaptively supporting a plurality of real-time jobs or active objects. For simplified explanation, the term ‘job’ will be used to denote either real-time jobs or active objects. Each accepted job is provided with a high-level polling procedure 1301a-1301n. Each polling procedure, when active, launches a query 1302a-1302n to its associated job. When the job is completed, the job returns a status flag in its return step 1303a-1303n to the dispatch loop. This completes that job's polling procedure and the dispatch loop then moves 1304a, etc., to the next that job's polling procedure 1301a-1301n.

The right portion of FIG. 13 illustrates exemplary real-time jobs and an exemplary job execution environment. A general job may have the form depicted in FIG. 13 for the exemplary Additional Processing Job 1355. For that example, the relevant query 1302a-1302n is received as query 1352. The query begins a test stage 1356 within the job. Depending on the results obtained the test stage 1356, there may be one or more actions taken in an action stage 1357 before returning to the dispatch loop, or no action may be taken and the return to the dispatch loop is immediate. In all cases the job returns a status flag created in a status flag stage 1358 before returning 1353 to its associated job polling procedure among 1301a-1301n.

In addition to the exemplary Additional Processing Job 1355, FIG. 13 illustrates three exemplary implementations of more specific jobs:
After receiving initiating dispatch loop query 1332, an exemplary A/D Processing Job 1335 performs a hardware check in its test step 1336. If this test indicates the associated A/D hardware is ready with a new sample value, the job 1335 then executes a (time-bounded) task to transfer this value to the associated allocated decoder in an action step 1337. A status flag is then created at 1338 and the job returns 1313b to the dispatch loop. If the test step 1336 determines no action is to be taken, the job 1335 proceeds immediately to creating the status flag step 1338 and the job returns 1333 to the dispatch loop with no action being taken;
After receiving initiating dispatch loop query 1342, an exemplary D/A Processing Job 1345 performs a queue and time check in its test step 1346. If this test indicates the queue has an entry and the time is correct, the job 1345 then executes a (time-bounded) task to transfer this value to the associated allocated encoder in an action step 1347. A status flag is then created 1348 and the job returns 1313c to the dispatch loop. If the test step 1346 determines no action is to be taken, the job 1345 proceeds immediately to creating the status flag step 1348 and the job returns 1343 to the dispatch loop with no action being taken;
As indicated above, the real-time job manager itself may be implemented as a co-executing job or active object. An exemplary real-time job manager, itself a job 1325, upon receiving initiating dispatch loop query 1322, performs a host message query in its test step 1326. If this test indicates there is a pending host message, the job 1325 then executes a (time-bounded) task to transfer this value to the associated allocated encoder in an action step 1327. A status flag is then created 1328 and the job returns 1323a to the dispatch loop. If the test step 1326 determines no action is to be taken, the job 1325 proceeds immediately to creating the status flag step 1328 and the job returns 1323 to the dispatch loop with no action being taken.

### 2.7 Exemplary Low-Level Task Aggregation

An exemplary aggregation of low-level tasks associated with implementing an instance of the signal flow is now considered. Such aggregation results in a smaller collection of real-time jobs or active objects with a more uniform structure to ease reconfiguration actions, all in keeping with the points of Section 2.5. The resulting jobs would be those of the type to be handled in the exemplary real-time process management environment depicted in FIG. 13.

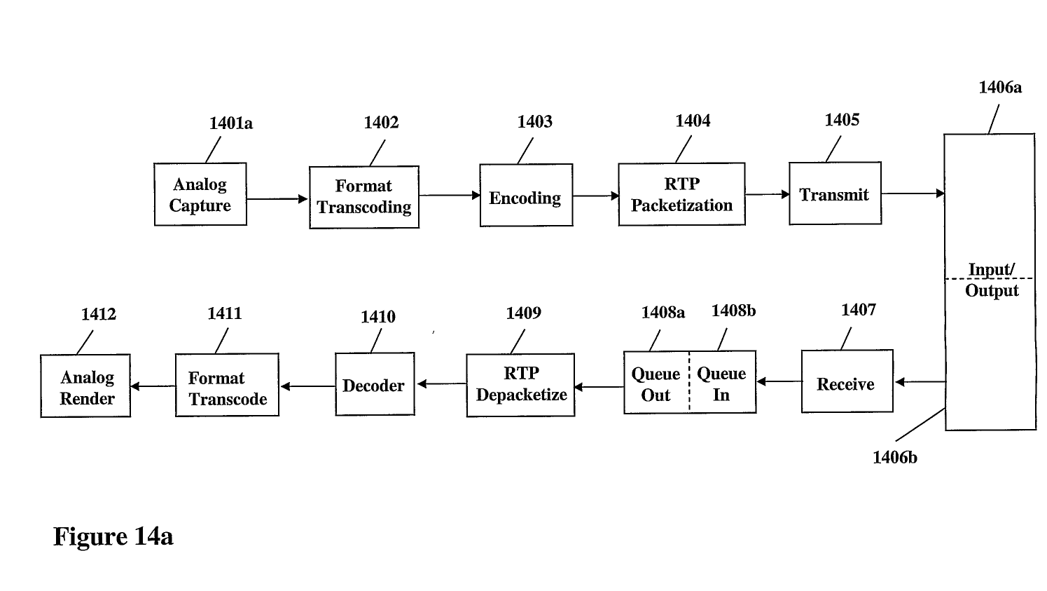

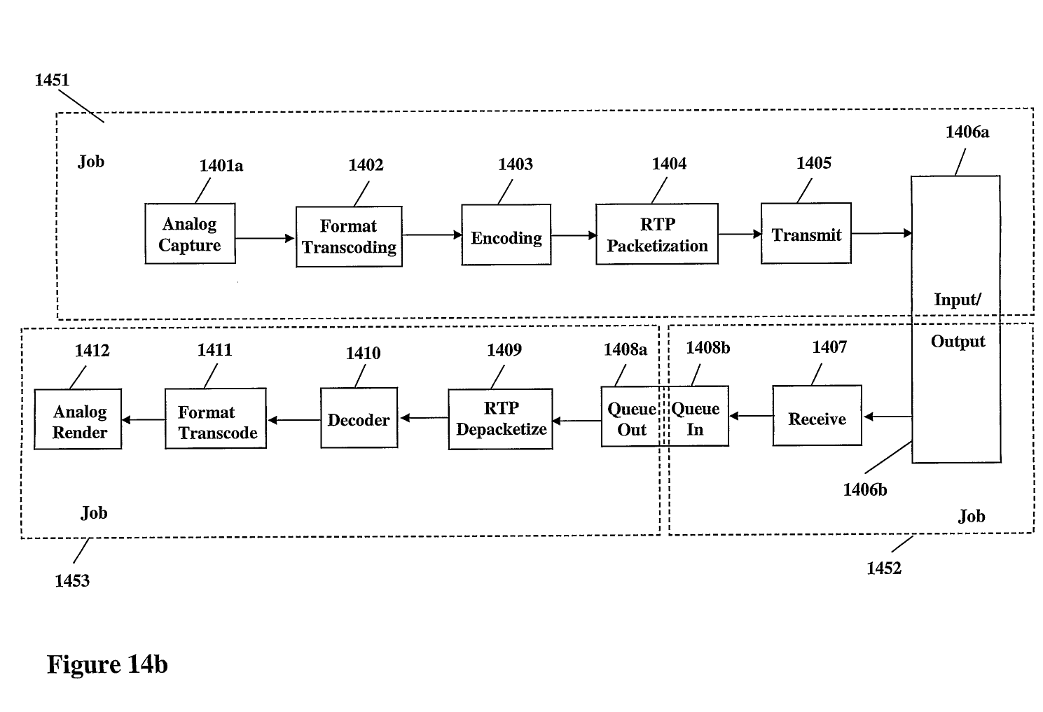

The example chosen and depicted in FIGS. 14a-14b is the video signal flow for the bidirectional codec operation procedure depicted in FIG. 12a. The audio signal flow has the same steps. An exemplary transcoding video and audio signal flow would similar in high-level form, but with different details, as would be clear to one skilled in the art.

FIG. 14a shows the individual steps involved in the two directional paths of data flow for this example. The first path in this flow is the analog capture step 1401 involving an analog-to-digital converter. The captured sample value is reformatted at 1402 and then presented for encoding at 1403. The media processor transforms a video frame's worth of video samples into a data sequence for RTP-protocol packetization, which occurs in a packetization step 1404. The packet is then transmitted by 1405 out to the local controlling processor I/O 1406a for transmission onto the IP network by subsequent actions of the local controlling processor. The second task in this flow begins with a local controlling I/O exchange 1406b into a packet receive task 1407 which loads a packet queue 1408a. When this packet queue is polled and found to be non-empty, the packet is removed at 1408b and depacketized at the RTP level 1409. The resulting payload data is then directed to a decoding operation 1410. The result is reformatted 1411 and directed to a digital-to-analog converter for analog rendering 1412.

Although the individual steps may be handled in somewhat different ways from one implementation to another, this exemplary implementation is representative in identifying fourteen individual steps. Modularizing groups of these steps into a smaller number of real-time jobs in a structurally and functionally cognoscente manner as described in Section 2.5 makes the initiation, periodic servicing, management, and deactivation far easier to handle. One example aggregation, represented in FIG. 14b, would be:
Aggregate steps 1401, 1402, 1403, 1404, 1405, and 1406a into a first job. This first job is equivalent or comparable to the A/D Processing Job 1335 depicted in FIG. 13;

Aggregate steps 1406b, 1407, and 1408b into a second job. In some implementations this job may be viewed as just an instance of other similar tasks that match the function of the Real-Time Job Manager job 1325 which checks the local controlling processor message queue. In other implementations, the received and transmitted packets may be routed through (a) separate ‘non-message’ local controlling processor packet I/O path(s);
Aggregate steps 1408a, 1409, 1410, 1411, and 1412 into a third job. This second job is equivalent or comparable to the D/A Processing Job 1345 depicted in FIG. 13.

In this exemplary implementation, all three of these jobs would execute on the media processor. Other arrangements are also possible and provided for in the invention.

### 2.8 Exemplary Protocol Task Partitions Between Low-Level and High-Level Processors

In reference to the discussion above, the invention provides for alternative implementations which split the tasks of FIG. 14 into smaller jobs, some of which are executed by a media processor and some executed by an associated local processor. Such an exemplary alternative implementation (not depicted in the figures) is:
Aggregate steps 1401, 1402, and 1403 into a first job, this job executed on a media processor;
Aggregate steps 1404, 1405, and 1406a into a second job, this job executed on the associated local controlling processor;
Aggregate steps 1406b, 1407, and 1408a into a third job, this job executed on the associated local controlling processor;
Aggregate steps 1408a and 1409 into a fourth job, this job executed on the associated local controlling processor;
Aggregate steps 1410, 1411, and 1412 into a fifth job, this job executed on a media processor.
   Since distributed processing is involved for these two exemplary groups of jobs (one group for media processors, one group for local controlling processors associated with the media specific processor), there are two scheduling loops such as that depicted in FIG. 13. One of these loops is for the specific media processor and the scheduling of its group of jobs, while the other is for the associated local controlling processors and the scheduling of its group of jobs. These scheduling loops can readily be designed to independently free run, each checking for messages/flags from associated loops. Further, as a given local processor may be (statically or dynamically) associated with a plurality of media processors, a common scheduling loop may be used to merge and sequentially service the entire collection of jobs associated with all of its (statically or dynamically) associated media processors.

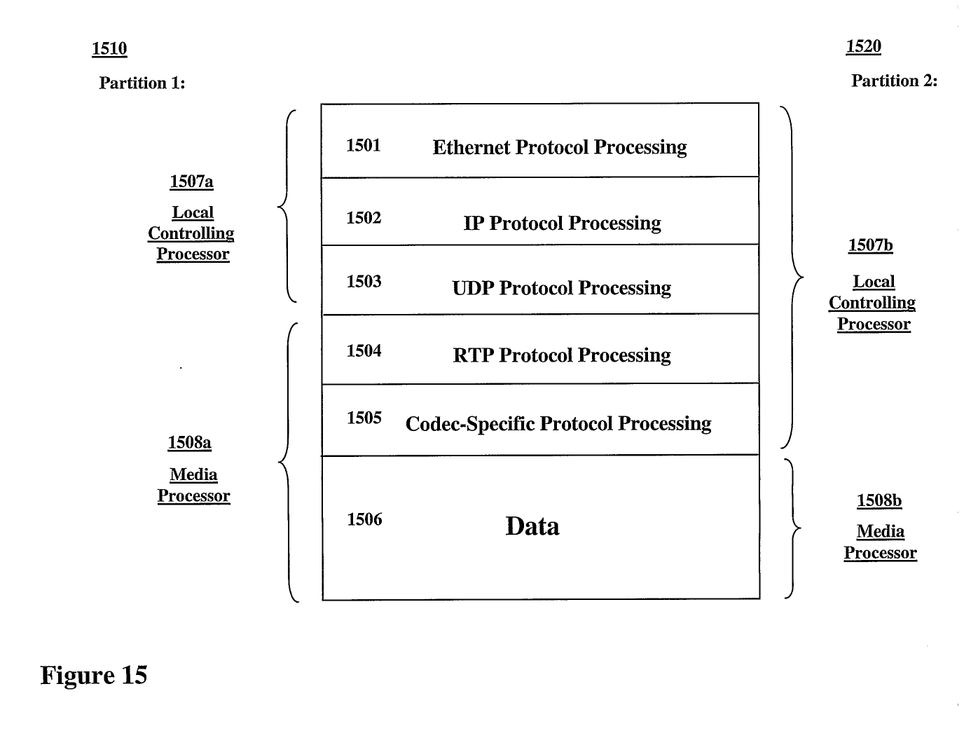

With regards to protocol processing, FIG. 15 illustrates exemplary ranges and selections of choices of protocol task allocation between a media processor and an associated local controlling processor. The tasks requiring handling in packet protocol actions include, for an Ethernet-based example, Ethernet protocol processing 1501, IP protocol processing 1502, UDP protocol processing 1503, RTP protocol processing 1504, any codec-specific protocol processing 1505, and actual data payload 1506. Two example partitions of these tasks between processors are provided for the sake of illustration.

In the first example (“Partition 1”), the selected media processor from the collection 1109a-1109n would be responsible for RTP protocol processing 1504, codec-specific protocol processing 1505, and finally the operations on the actual data payload 1506. The rest of the protocol stack implementation would be handled by the local controlling processor 1118. In the second example (“Partition 2”), the selected media processor is only responsible for operations on the actual data payload 1506, leaving two additional protocol stack implementation tasks 1504, 1505 to instead also be handled by the local controlling processor.

In comparison, Partition 1 spares the local controlling processor from a number of processing tasks and thus scales to larger implementations more readily than Partition 2. However, Partition 2 limits the loading on the media processors, giving more computational capacity for protocol handling.

In the preceding description, reference was made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. The various principles, components and features of this invention may be employed singly or in any combination in varied and numerous embodiments without departing from the spirit and scope of the invention as defined by the appended claims. For example, the system need not be hosted in a bus-based system but rather those I/O connections may be brought out as standard signal connectors, allowing the system essentially as described in a freely stand-alone implementation without physical installation in a host system chassis.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, per, shell, PHP, Java, etc.

Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1-76. (canceled)

77. A video conferencing multipoint control unit, comprising:
at least two signal converting means, each for converting an incoming signal conforming to one of a variety of analog and digital signal formats into an uncompressed digital stream; and
at least one signal processor, receiving at least two uncompressed digital streams, and selecting at least one of them as output.

78-94. (canceled)

95. A signal processing system comprising:
A plurality of video signal encoders, each for encoding a video signal into a compressed digital video data-stream;
a plurality of video signal decoders, each for decoding a compressed digital video data-stream into a video signal;
reconfigurable signal connection among the plurality of video signal encoders and the plurality of video signal decoders; and
at least one local controlling processor,
wherein the at least one local controlling processor managing
the operation of at least one of the plurality of video signal encoders and at least one of the plurality of video signal decoders;
the operation of the reconfigurable signal connection among the plurality of video signal encoders and the plurality of video signal decoders.

96. The system of claim 95, wherein at least one of the plurality of video signal encoders is reconfigurable.

97. The system of claim 95, wherein at least one of the plurality of video signal decoders is reconfigurable.

98. system of claim 95, wherein at least one of the plurality of video signal encoders and at least one of the plurality of video signal decoders are capable of being dynamically reconfigured to implement a transcoding operation, wherein the transcoding operation converts an input video signal conforming to a first compression standard to an output video signal conforming to a second compression standard.

99. The system of claim 95, wherein at least one of the plurality of video signal encoders and at least one of the plurality of video signal decoders are capable of being dynamically reconfigured to implement a video mosaic operations.

100. The system of claim 95, wherein at least one of the plurality of video signal encoders is capable of being dynamically reconfigured to support a video storage system.

101. The signal processing system of claim 95, wherein at least one of the plurality of video signal encoders is operable to additionally simultaneously execute an audio encoding process.

102. The signal processing system of claim 95, wherein at least one of the plurality of video signal decoders is operable to additionally simultaneously execute an audio decoding process.

103. The signal processing system of claim 95, wherein the at least one local controlling processor is configured to oversee start, operation, and completion of a plurality of sessions, and further is configured to associate at least one of the plurality of video signal decoders with each of the plurality of sessions.

104. The signal processing system of claim 95, wherein the at least one local controlling processor is configured to oversee start, operation, and completion of a plurality of sessions, and further is configured to associate at least one of the plurality of video signal encoders with each of the plurality of sessions.

105. The signal processing system of claim 95, wherein at least one of the plurality of video signal decoders is operable to simultaneously execute a plurality of video decoding processes.

106. The signal processing system of claim 101, wherein at least one of the plurality of video signal encoders is operable to simultaneously execute a plurality of video encoding processes.

107. A signal processing system comprising:
a plurality of reconfigurable signal processors, each of which is arranged to operate as at least a video encoder for encoding a video signal into a compressed digital video data-stream and as at least a video signal decoder for decoding a compressed digital video data-stream into a video signal;
reconfigurable signal connection among the plurality reconfigurable signal processors; and
at least one local controlling processor,
wherein the at least one local controlling processor is arranged for managing the operation of the plurality of reconfigurable signal processors and the operation of the reconfigurable signal connection among the plurality of reconfigurable signal processors.

108. The system of claim 107, wherein at least two of the plurality of reconfigurable signal processors are capable of being dynamically reconfigured to implement a transcoding operation, wherein the transcoding operation converts an input video signal conforming to a first compression standard to an output video signal conforming to a second compression standard.

109. The system of claim 107, wherein at least two of the plurality of reconfigurable signal processors are capable of being dynamically reconfigured to implement a video mosaic operations.

110. The system of claim 107, wherein at least one of the plurality of reconfigurable signal processors is capable of being dynamically reconfigured to implement a to support a video storage system.

111. The signal processing system of claim 107, wherein at least one of the plurality of reconfigurable signal processors is operable to additionally simultaneously execute an audio encoding process.

112. The signal processing system of claim 107, wherein at least one of the plurality of reconfigurable signal processors is operable to additionally simultaneously execute an audio decoding process.

113. The signal processing system of claim 107, wherein the at least one local controlling processor is configured to oversee start, operation, and completion of a plurality of sessions, and further is configured to associate at least one of the plurality of reconfigurable signal processors with each of the plurality of sessions.

114. The signal processing system of claim 107, wherein at least one of the plurality of reconfigurable signal processors is operable to simultaneously execute a plurality of video decoding processes.

115. The signal processing system of claim 107, wherein at least one of the plurality of reconfigurable signal processors is operable to simultaneously execute a plurality of video encoding processes.

116. A signal processing system comprising:
a plurality of reconfigurable media signal processors dynamically reconfigurable to perform at least one of:
a video encoding operation to encode video signal into compressed digital video data-stream, wherein the video encoding operation is any one of a first plurality of compression formats; and
a video decoding operation to decode compressed digital video data-stream into video signal, wherein the video decoding operation is any one of a second plurality of compression formats;
at least one local controlling processor to perform reconfiguration actions associated with the plurality of dynamically reconfigurable media signal processors, to receive a session request, to identify resources required for the requested session, and to allocate the identified resources to the requested session;
wherein the at least one local controlling processor performs at least one of:
selection of encoding algorithms;
selection of decoding algorithms;
selection of network protocol algorithms; and
arranging for the dynamically reconfigurable media signal processors to be interconnected for the duration of the requested session.

117. The signal processing system of claim 116, further comprising at least one reconfigurable signal connection system to route video signals among the plurality of reconfigurable media signal processors.

118. The signal processing system of claim 117, wherein the at least one local controlling processor selects a signal routing configuration of the at least one reconfigurable signal connection system.

119. The signal processing system of claim 116, wherein one or more tasks associated with signal processing are flexibly allocated between the at least one local controlling processor and one or more reconfigurable media signal processors of the plurality of reconfigurable media signal processors.

120. The signal processing system of claim 116, wherein at least one of the plurality of reconfigurable media signal processors is associated with at least one of:
an audio signal encoder component operable to encode audio signals; and
an audio signal decoder component operable to decode audio signals.

121. The signal processing system of claim 116, wherein at least one of the plurality of reconfigurable media signal processors is associated with at least one of:
a video signal encoder, of a plurality of video signal encoders, the video signal encoder for encoding using any one of the first plurality of compression formats; and
a video signal decoder, of a plurality of video signal decoders, the video signal decoder for decoding using any one of the second plurality of compression formats.

122. The signal processing system of claim 116, wherein at least one of the plurality of reconfigurable media signal processors is associated with at least one of:
a plurality of bundled analog-to-digital elements and digital-to-analog elements; and
a plurality of unbundled analog-to-digital elements and digital-to-analog elements.

123. The signal processing system of claim 116, further comprising an internal analog switching capability between at least one bundled analog-to-digital/digital-to-analog elements and at least one connection to route signals from external signal sources to signal destinations.

124. The signal processing system of claim 116, further comprising an internal analog switching capability between at least one unbundled analog-to-digital/digital-to-analog elements and at least one connection to route signals from external signal sources to signal destinations.

125. The signal processing system of claim 116, further comprising an internal digital switching capability between at least one bundled analog-to-digital/digital-to-analog elements and at least one connection to route signals from external signal sources to signal destinations.

126. The signal processing system of claim 116, further comprising an internal digital switching capability between at least one unbundled analog-to-digital/digital-to-analog elements and at least one connection to route signals from external signal sources to signal destinations.

127. The signal processing system of claim 116, wherein at least one of the plurality of reconfigurable media signal processors comprises:
one or more bundled video signal encoder decoder pairs.

128. The signal processing system of claim 116, wherein at least one of the plurality of reconfigurable media signal processors comprises:
a plurality of unbundled video signal encoders.

129. The signal processing system of claim 116, wherein at least one of the plurality of reconfigurable media signal processors comprises:
a plurality of unbundled video signal decoders.

130. The signal processing system of claim 116, wherein at least one of the plurality of reconfigurable media signal processors comprises:
at least one unbundled video signal encoder and at least one unbundled video signal decoder.

131. The signal processing system of claim 116, operable to concurrently broadcast video conforming to a plurality of different video signal formats.

132. The signal processing system of claim 116, wherein at least one of the plurality of reconfigurable media signal processors is operable to execute concurrently at least one independent encoding process, and a plurality of independent decoding processes, wherein at least two of the plurality of independent decoding processes employ different compression algorithms.

133. The signal processing system of claim 116, further comprising an internal digital switching capability for providing a signal path for at least one of:
a first signal flow between one of the video signal encoders at a first reconfigurable media signal processor from the plurality of reconfigurable media signal processors and one of the video signal decoders at a second reconfigurable media signal processor from the plurality of reconfigurable media signal processors;
a second signal flow between one of the video signal encoders at the first reconfigurable media signal processor from the plurality of reconfigurable media signal processors and one of the video signal decoders at the first reconfigurable media signal processors;
a third signal flow that concurrently feeds a decoded signal from one of the video signal encoders at the first reconfigurable media signal processor to video signal decoders corresponding to the second and a third reconfigurable media signal processors; and
a fourth signal flow that concurrently feeds the decoded signal from one of the video signal encoders at the first reconfigurable media signal processor to video signal decoders corresponding to the first, second and third reconfigurable media signal processors.

134. The signal processing system of claim 116, further comprising an internal analog switching capability for providing a signal path for at least one of:
a first signal flow between one of the video signal encoders at a first reconfigurable media signal processor from the plurality of reconfigurable media signal processors and one of the video signal decoders at a second reconfigurable media signal processor from the plurality of reconfigurable media signal processors;
a second signal flow between one of the video signal encoders at the first reconfigurable media signal processor from the plurality of reconfigurable media signal processors and one of the video signal decoders at the first reconfigurable media signal processors;
a third signal flow that concurrently feeds a decoded signal from one of the video signal encoders at the first reconfigurable media signal processor to video signal decoders corresponding to the second and a third reconfigurable media signal processors; and
a fourth signal flow that concurrently feeds the decoded signal from one of the video signal encoders at the first reconfigurable media signal processor to video signal decoders corresponding to the first, second and third reconfigurable media signal processors.

135. The signal processing system of claim 116, further comprising:
at least one video storage; and
at least one playback encode-decode-transcode engine.

136. The signal processing system of claim 116, wherein the at least one local controlling processor is configured to oversee start, operation, and completion of a plurality of sessions, and is further configured to associate at least one of a plurality of video signal decoders with at least one task that is associated with the plurality of sessions, wherein the at least one video signal decoder is associated with at least one reconfigurable media signal processor.

137. The signal processing system of claim 116, wherein the at least one local controlling processor is configured to oversee start, operation, and completion of a plurality of sessions, and is further configured to associate at least one of a plurality of video signal encoders with at least one task that is associated with the plurality of sessions, wherein the at least one video signal encoder is associated with at least one reconfigurable media signal processor.

138. The signal processing system of claim 116, wherein at least one reconfigurable media signal processor is capable of being dynamically reconfigured to implement video mosaic operations.

139. The signal processing system of claim 116, wherein respective reconfigurable media signal processor is reconfigurable by dynamically downloading software to the respective reconfigurable media signal processor in response to a request presented to the signal processing system.

140. A method for signal processing comprising:
dynamically configuring a plurality of reconfigurable media signal processors for at least one of:
encoding video signal into compressed digital video data-stream, wherein the video encoding is associated with any one of a first plurality of compression formats; and
decoding video signal into compressed digital video data-stream into video signal, wherein the video decoding is associated with any one of a second plurality of compression formats;
performing reconfiguration actions associated with the plurality of dynamically reconfigurable media signal processors, receiving a session request, identifying resources required for the requested session, and allocating the identified resources to the requested session; and
performing at least one of:
selecting encoding algorithms;
selecting decoding algorithms;
selecting network protocol algorithms; and
arranging for the dynamically reconfigurable media signal processors to be interconnected for the duration of the requested session.

141. The method of claim 140, further comprising using at least one reconfigurable signal connection system to route video signals among the plurality of reconfigurable media signal processors.

142. The method of claim 141, further comprising using at least one local controlling processor for selecting a signal routing configuration of the at least one reconfigurable signal connection system.

143. The method of claim 140, flexibly allocating one or more tasks associated with signal processing between at least one local controlling processor and one or more reconfigurable media signal processors of the plurality of reconfigurable media signal processors
